(19) United States
(12) Patent Application Publication
(10) Pub. No.: US 2001/0034640 A1
(43) Pub. Date: Oct. 25, 2001

(54) Physical and digital secret ballot systems

(76) Inventor: David Chaum, Sherman Oaks, CA (US)

Correspondence Address: DAVID CHAUM, 14652 SUTTON ST., SHERMAN OAKS, CA, 91403, US

(21) Appl. No.: 09/771,537

(22) Filed: Jan. 29, 2001

Related U.S. Application Data
(60) Provisional application No. 60/177,717, filed on Jan. 27, 2000.
(60) Provisional application No. 60/261,290, filed on Jan. 13, 2001.

(51) Int. Cl. G06F 17/60

(52) U.S. Cl. 705/12

(57) ABSTRACT

Election automation systems are disclosed that allow plural entities, for example trustees, to ensure various properties of an election, including correctness of the outcome, by initially using confidential information to form printed ballots and transferring the ballots to voters. Later when voters electronically cast ballots, such as over networks, they use the confidential information and optionally physical ballot structures to authenticate information provided them, including information indicating whether their votes were received by the trustees. Voters can also use the information in ballots to ensure the secrecy of their vote while it is transmitted to the trustees. The trustees can tabulate results while preventing colluding subsets of trustees from being able to improperly modify the outcome of the election or violate the privacy of individual voters.

Some embodiments secure printing from remote locations, authenticate users in distributed systems, authenticate data to users in distributed systems, and address problems with conventional voter registration and absentee ballots.

The present application claims priority from U.S. Provisional Applications, by the present applicant, titled “Voting Systems,” including U.S. PTO No. 60/177,717, Jan. 27, 2000 and U.S. PTO No. 60/261,290, Jan. 13, 2001.

### BACKGROUND OF THE INVENTION

1. Field of the Invention

The present invention relates generally to document and electronic security techniques, and more specifically to secure and/or privacy protecting techniques for election automation and authentication and secrecy of communication.

2. Description of Prior Art

Conventional election systems, whether or not voters physically attend a polling place, have substantial shortcomings. A major problem with conventional attendance voting is that ballot boxes need to be monitored closely until ballots are counted. Poll workers and observers must carefully oversee which ballots are added to boxes and prevent theft, destruction, and substitution of boxes. Counts are either conducted after sealed boxes are transported to a central counting site or by local sites that typically provide tallies by telephone. Either way, secure infrastructure and a substantial number of non-colluding overseers is needed at almost all sites, which may be expensive and/or hard to ensure. Moreover, once anonymous ballots are in ballot boxes and it later becomes clear that certain ones should not be counted because the corresponding voters were ineligible, there is no way to exclude them. All of these issues can make assurance of high-credibility too expensive.

Techniques not requiring voters to attend polling places include voting by mail and over open networks. Mail schemes are as a rule costly, slow, and often protect privacy poorly. Security and privacy concerns, among others, have ruled phone voting out at an early stage. Current open electronic networks are believed to be too vulnerable to provide the requisite security, lack infrastructure for identification of voters, and are not yet available enough to all groups for public-sector elections. Although there are inherent limits without overseers and booths to deterring non-voter influence, such as with coercion and vote selling, current systems leave significant room for improvement.

A more fundamental problem with know techniques-at least those that do not sacrifice privacy of votes or protection against non-voter influence-is the precious little certainty that each individual voter obtains about whether his or her intended vote is actually going to be counted.

The present invention has among its objectives to overcome these and other problems and economically provide more readily verifiable, robust, privacy protecting and high-assurance/high-credibility elections. In particular, plural secured sites are allowed to be located anywhere in the world and are arranged so that compromise of an election would require collusion or compromise of them all, raising the threat level beyond the means of almost any adversary. Also, after voting takes place, ineligible or multiple ballots can be kept from being counted. Ballots can be destroyed immediately after they are voted, eliminating the need for ballot boxes altogether. Whether with or without voter attendance, open telephone or computer networks can be used without concern for their privacy or security. Moreover, voting can be extremely simple and foolproof for voters yet provide each voter with immediate and definite confirmation from all the centers that they have recorded his or her vote for counting.

Other objects, features, and advantages of the present invention will be appreciated when the present description and appended claims are read in conjunction with the drawing figurers.

### BRIEF DESCRIPTION OF THE DRAWING FIGURES

FIG. 1 shows a combined block, functional, and flow diagram is presented for an exemplary embodiment in accordance with the teachings of the present invention.

FIG. 2 shows an example paper ballot illustrating some of the inventive concepts is shown in plan view.

FIG. 3 shows a combination block, functional and flow diagram of the overall process of an example embodiment in accordance with the teachings of the present invention.

FIG. 4 shows a combination block, functional and flow diagram of the making of ballots in an example embodiment is presented in accordance with the teachings of the present invention.

FIG. 5 shows a combination block, functional and flow diagram in an example embodiment of the actual casting of ballots by voters in accordance with the teachings of the present invention.

FIG. 6 shows a combination block, functional and flow diagram of the decision as to what to count in an example embodiment in accordance with the teachings of the present invention.

FIG. 7 shows a combination block, functional and flow diagram of the overall process in accordance with the teachings of the present invention of, at last, actually counting ballots.

FIG. 8 shows four formula schema are shown, one corresponding to the output of each of the four phases of one example embodiment in accordance with the teachings of the present invention.

FIG. 9 shows a combination block, functional, schematic and flow diagram of a pre-computation phase for an example embodiment in accordance with the teachings of the present invention.

FIG. 10 shows a combination block, functional, schematic and flow diagram of a first pass for an example embodiment in accordance with the teachings of the present invention.

FIG. 11, a combination block, functional, schematic and flow diagram of a second pass of an example embodiment in accordance with the teachings of the present invention.

FIG. 11 shows a combination block, functional, schematic and flow diagram of a post-computation of an example embodiment in accordance with the teachings of the present invention.

FIG. 13 shows a first and final part of an example computation in accordance with the invention is provided to allow the concepts to be more readily appreciated.

FIG. 14 shows middle stages of an example computation in accordance with the invention is provided.

FIG. 15 shows five example ballot state scenarios in accordance with the teachings of the present invention.

FIG. 16 shows a combination block, functional, and flow diagram for an example audit concept in accordance with the invention.

FIG. 17 shows four example forms in accordance with the teachings of the present invention.

FIG. 18 shows three example ballot sets in accordance with the present invention.

FIG. 19 shows details an example ballot form that illustrates variations in general form and also shows a serial number all in accordance with the invention.

FIG. 20 shows an alternate non-permuted embodiment to that of FIG. 2 in accordance with the teachings of the invention.

FIG. 21 shows an example PIN code ballot part in accordance with the teachings of the invention.

FIG. 22 shows an example self-shredding ballot part in accordance with the teachings of the invention.

FIG. 23 shows an example self-shredding PIN code ballot part in accordance with the teachings of the invention.

FIG. 24 shows example retained-record ballot parts in accordance with the teachings of the invention.

FIG. 25 shows two example write-in ballot parts in accordance with the teachings of the invention.

FIG. 26 shows an example type-in ballot part in accordance with the teachings of the invention.

FIG. 27 shows an example interactive ballot part in accordance with the teachings of the invention.

FIG. 28 shows an example countersign-selected ballot part in accordance with the teachings of the invention.

FIG. 29 shows an example probabilistic-count ballot part in accordance with the teachings of the invention.

FIG. 30, an example first passive ballot in accordance with the teachings of the invention.

FIG. 31 shows an example user interface screen device in accordance with the teachings of the present invention.

FIG. 32 shows a view of a first example combination of a visual display and ballot in accordance with the present invention.

FIG. 33 shows a view of a second example combination of a visual display and ballot form in accordance with the present invention.

FIG. 34 shows an example securely-printable form in accordance with the present invention.

FIG. 35 shows an example printer functional, block, and schematic diagram in accordance with the teachings of the invention.

FIG. 36 shows an example serial configuration of multiple printers illustrated in a combination block, functional, and schematic diagram and in accordance with the invention.

FIG. 37 shows an example combination schematic, functional and block diagram for an exemplary networked voting system in accordance with the teachings of the present invention.

FIG. 38 shows an example reader in side view and corresponding section through a ballot being read all in accordance with the invention.

FIG. 39 shows an example combination schematic, functional and block diagram for a reader in accordance with the teachings of the present invention.

FIG. 40 shows an example counterfoil reader/writer in accordance with the invention is shown in combination block, plan, schematic, and section illustrations.

FIG. 41 shows an example combination schematic, functional and block diagram for a exit processors in accordance with the teachings of the present invention.

### BRIEF SUMMARY OF THE INVENTION

This section introduces some of the basic ideas of the invention, but makes significant simplifications and omissions for clarity and should not be taken to limit its scope in any way; the next section presents a more general view.

In broad summary and a simplified example, an improved method for voting is as follows: a person votes by opening an envelope having a public serial number, choosing and reading aloud secret information from the contained card corresponding to the candidates chosen, verifying confirmation information heard or seen against that printed on the card, and shredding or otherwise destroying the card. In some other examples, information can be communicated to an automated intermediary by manipulating user interfaces, such as buttons or reading devices, and responses can be visual, such as with displays or printers.

The election process in one embodiment comprises four basic phases: preparation of the envelopes; voters voting; deciding which ballots, identified by their serial or other unique numbers, to count; and counting the votes. (Registration and deciding who can cast votes are considered part of voting for clarity.) A number of trustees participate in all but the third phase, no proper subset of which should be able to learn which vote corresponds to which serial number or change the outcome of the election.

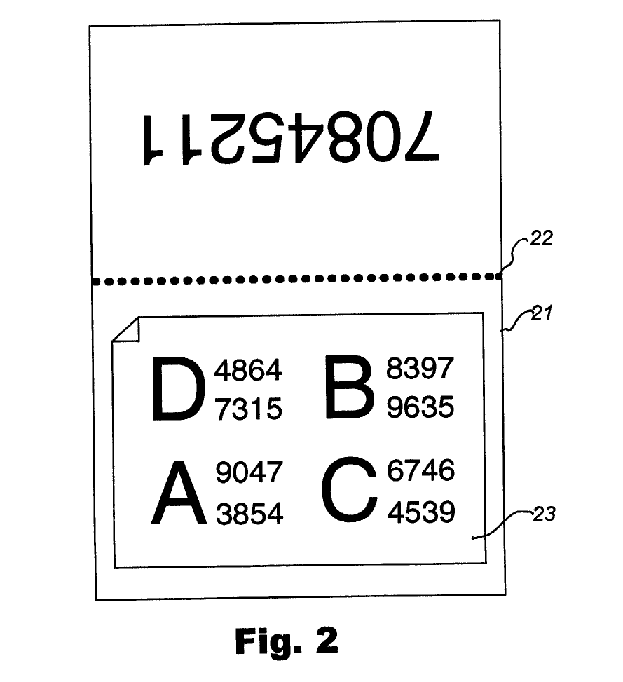

In the first phase, the trustees cooperate in printing the ballots that are placed inside the envelopes. Each envelope has a serial number on the outside. On the ballot card sealed inside the envelope, the part that should be the secret of the voter who opens the envelope, multiple triples are printed. Each triple is a symbol and a pair of, say, four-digit numbers. In the present example, the symbols will, for simplicity, be shown as “A”, “B”, “C”, and “D”, which in practice can be the actual names of the candidates or references to them. An example ballot of this form is shown in FIG. 2, as will later be described in detail.

The second phase is voting in which voters participate. The voter is first presented with an envelope having a serial number. This number might, for instance, be videotaped as the voter holds the envelope or be associated with the voter as identified in a traditional registration process. The triples are intended to only be seen by the voter after opening the envelope, such as in a booth or in a way that does not reveal the contents to onlookers. After using the numbers to vote, in some exemplary embodiments, the voter should destroy the envelope, preferably immediately, for instance with a reasonably transparent shredder provided for this purpose.

To vote for a particular candidate, say, ‘B’, the voter first locates the triple containing the symbol ‘B’. To prevent the motion of the voter's eyes from revealing which triple is chosen, symbols and their triples optionally do not appear in the same or know positions in each ballot. After locating the desired triple, the voter communicates the triple's first four digit number. The communication or “uttering” of such numbers by the voter can for instance be by reading the number aloud, entering the number on a phone or terminal, and/or bringing a reader wand, such as a barcode reader, into contact with the number.

This number is relayed to the trustees, along with the serial number. They are able to compute, by cooperating among themselves, the second four digit number of the triple, and this number is presented to the voter, such as audibly, visually, or automatically to a reader wand. The voter can verify, optionally or as a required part of the process, that this number is the same as that printed, and as a result obtain confidence that his or her vote has actually been received by the trustees.

In phase three it is agreed amongst the trustees which ballots not to count. After voting, it may be learned that certain ballots should not be counted, such as those having been used without being associated with a valid voter, by a valid voter who has voted more than once, or otherwise contrary to set rules. This phase results in agreement on the set of serial numbers whose ballots are to be excluded, or equivalently which are to be included, in the totals.

In phase four, once phase three has been completed and it is agreed which ballots are to be counted, the counting can begin. The counting process can reveal whatever aggregated information is agreed it should reveal about how the ballots were voted while hiding more detailed information. In a simple plurality contest example, where each voter may vote for at most one candidate, the output can be the total number of votes for each candidate or even just the name of the winner. One way to achieve such a result is by a cryptographic protocol performed by the trustees.

### GENERAL DESCRIPTION

As will be appreciated, certain terminology that has been and/or will be used is now defined at least generally collected together here (although some detailed definitions elsewhere provide further options):

A “challenge” or “vote code” is the secret information obtained from the ballot forms by the voter or an automated intermediary and supplied in casting a vote of whatever kind.

The corresponding responsive codes returned to the voter, and/or intermediaries, are called “responses” or “countersigns”.

The “trustees” sometimes also referred to more broadly as “servers” cooperate at least in some combinations and/or through functionaries and/or machines. The function of one or more trustees, however arranged and constituted, is to provide trusted use of secrets, and/or trusted storage of data, supportive of the overall functioning of at least some aspects of a voting system.

A “relay” or “intermediary” is an entity, device, or channel through which challenge and/or response information flows between one or more voters and the trustees/servers.

The term “ballot” refers to a medium bearing confidential data from one or more trustees through one or more printers to an intended voter/user, and also more broadly to refer to associated forms employed in combination with such media The function of a “ballot” is to communicate secret information from trustees to voters and provides confidentiality and/or authenticity of the information.

The “envelope” is generally a hiding device/system for the ballot.

A “ballot card” is the part of a multi-part ballot that contains the challenges and/or responses secret to the voter.

A “serial number” is a preferably unique sequence of symbols used, among other things, to identify and/or link documents that bear it in the form of indicia and generally need not be a sequential or other special numbering.

A vote will be said to be “lodged” if it has been communicated to the trustees/servers in time for the serial number of that vote to be included among those selected so that it can, if its serial number is included and/or not excluded, be counted.

The term “destructible” layer will be used here for clarity and will apply broadly to any layer or structure that bears information that is then substantially destroyed and/or rendered unreadable in order to reveal additional information, with latex as an example.

A ballot is “self-shredding” if after normal voting use it does not reveal the candidates voted.

A system may be called “interactive”, if the possible actions of the voter that are considered valid differ because of the particular countersign supplied.

A “passive ballot” uses responses not initiated by corresponding challenges.

The example systems already summarized will first be expanded on here generally to introduce some inventive concepts but without implying any limitation.

Printing of ballots is done by one or more devices that are preferably arranged physically so that it can be readily verified that they do not retain a record of what is printed on each ballot, as will be described. The serial number, however, can be printed in a public way on the outside of envelopes.

Ballots are printed, in cooperation with the trustees, using devices that should not be able to retain secret data or communicate such data. Other communication facilities should be absent and/or blocked, memory should be limited, automatically erased between ballots, and/or destroyed after printing is completed. Each trustee supplies, such as by separate cryptographic channels, data that the printer combines to determine what to print. For instance, each four-digit (as in the example, but without limitation) challenge or response number can be created as the modulo 10,000 sum of a corresponding number supplied by each trustee. The circular shift corresponding to the letter placement in the example, the “letter shift” for short, would be calculated in a similar manner: each trustee supplies a number, these are added and reduced modulo four. Thus, if the letter-shift is zero, then they appear ‘ABCD’, if the letter-shift is one they are ‘BCDA’, two gives ‘CDAB’, and three ‘DABC’.

During phase two, in the example case of the casting of votes for the single candidate of a single contest, the serial number of the ballot, as well as one of the four-digit numbers, the “challenge”, which corresponds to the candidate selected by the voter, are made public or at least known to the trustees. The trustees each reveal the four contributions they made to each challenge for that particular serial number in the same order in which they provided them for printing. Combining all of these “potential challenge contributions” for the serial number yields a list of the potential challenges for that ballot.

The challenge issued by the voter should appear within the list, making the challenge's position within the list, the “index”, apparent Then, each trustee releases their contribution to the second four-digit number with this index, but nothing for any of the other three “potential responses” not chosen by the voter. These “response contributions” can be added modulo 10,000 to determine the actual “response” number. When the voter receives the response, the voter should verify that the response is the same as that printed on the ballot and then knows that, at least with high-probability, the vote has been lodged at least with the trustees.

As will be appreciated, various automation may be employed in this process. For instance, a telephone operator, an automated telephone interactive voice response system or a website can be interacted with by the voter. Particularly when voting is by attendance at a polling place, a reader device can allow the voter to selectively transmit challenges and provide verification of responses. Special readers can participate in production and delivery to the voter of confirming receipts and control the automated destruction of documents.

Phase three provides time to decide which ballots, identified by their serial numbers, should be counted. For instance, some ballots may never have been properly delivered or voted and others may be known to have been voted by ineligible voters. By looking at video recordings of the actual voting, or checking biometrics or other records, it may be determined that certain people voted more than once; all but one, or perhaps all, of the ballots of someone voting more than once should presumably be disqualified. The decision can be made by any agreed party or parties, and these may or may not include the trustees, however, the result of phase three would be that which is acted upon by the trustees in phase four.

One example counting protocol will now be described in some detail, without limitation, comprising four passes: a public “pre-computation”, two successive passes through the whole set of trustees, and finally a public “post3 computation.” In overview, the pre-computation biases each ballot according to the public position that the challenge number uttered and response number heard were in, resulting in digital values corresponding to each agreed serial number or other identifier. These digital values, in one embodiment, are pairs of numbers and may be referred to as “digital ballots”.

The first pass through the trustees leaves the digital ballots in the same order that they are in when input to the pass and thus each remains identified by its serial number. This pass involves the whole collection of ballots being processed successively by each of the trustees; first the first trustee processes all the ballots, then the second trustee processes the result, and so forth.

In the second pass, digital ballots are disconnected from their serial numbers. Each trustee removes encryption they left on the digital ballots in the first pass and permutes the order of the ballots before sending to the next trustee. Thus, the output of the second pass is a set of digital ballots whose ordering has been changed substantially by each trustee, and therefore collusion of less than all trustees will not be able to recover the order because of the permutation imposed by other trustees.

The post-processing involves the release of encryption keys by all the trustees, so that a final amount of encryption can be removed from all the ballots. Once these keys are released, parties with access can compute for which candidate is each digital ballot in the output batch was voted.

Adapting inventive concepts from the present invention to existing practice will be described as an example. For attendance voting, procedures exist for issuing ballots to voters. In some cases, the ballots will not be linked to the voter identity and current practice could be employed for controlled issue of ballots. In other cases, current practice somehow ties the identity of the voter to the voter's ballot and this can be achieved in the present invention by using an identifying indicia, such as a serial number, that is visible on the ballot without revealing the information that should be secret to the voter.

One example way would be for the serial number to be written on the voter roster by a pole worker next to the name of the voter. A second example would be for the ballot serial number to be scanned in and tied to voter identification information such as a barcode on the roster or information displayed to a poll worker. A third example uses a counterfoil from the ballot material that could then be attached, as a self-adhesive label, next to the voter name on the roster. Another example is a counterfoil that is marked with the voter identity, by writing or a self-adhesive label from the roster, and placed into a container for possible later use.

In a general election when essentially any resident should be able to vote, there may not be a voter registration infrastructure. One known approach to preventing double voting is to die a finger of those voting. A novel approach, however, would be to capture video images of voters voting. If the image contains or is associated with a ballot serial number, then the search for duplicates can be conducted until it is time for the tally. Other biometrics could be used, such as ear geometry, fingerprints, voiceprints, and so on. A voter might then be outside or up against a wall or otherwise clearly out of harms way and immune to observation from behind in the video, thereby also allowing the absence of certain coercion/influence scenarios to be verified.

Absentee ballots, or whenever voting does not take place in a controlled setting, generally referred to as “non-attendance” voting, can also use the inventive techniques to advantage. Absentee ballots can be given out to those who may be eligible or rather freely. When the absentee ballots are voted, eligibility data can be supplied or an interactive process conducted. Later, if the voter has voted in person as well, only the attendance ballot may be counted, to allow the voter to change his/her mind, as will be discussed also later. In casting an absentee ballot, the challenge and response can be read over the phone, in an automated and/or call center approach, or it could be over another type of network, such as the Internet, where whatever user interface, such as so called “web browsers,” might be employed.

Voting by mail in some jurisdictions/settings requires that, and in an example, a handwritten signature, fingerprint, or the like, is “physically sent in” by return mail or otherwise so that it can be verified. Traditionally, ballots have been sent in along with such authentication, reducing at least the perceived level of privacy assurance. The ballot serial number can be associated with that which has been physically sent in, such as for example, having it included on the form or counterfoil used. An extra layer of indirection can, for example, be inserted between what is physically sent in and a ballot serial number, such as an intermediary number that can be associated with the authentication by one entity and with whatever ballot number by another. During phase three, only those serial numbers that have been successfully authenticated would be considered for counting in phase four.

Inappropriate or otherwise undesired influence, such as, for example, vote selling and/or coercion and/or inducement and/or influence to vote a particular way on an absentee ballot is believed more difficult to discourage without attendance voting. A variety of inventive techniques can be applied to address this:

The in-person ballot, which might be conventional, can be set-up to override the absentee one, as mentioned; this allows people to change their mind afterwards, or, they can change their vote.

Requiring a PIN code in an election already means that an invalid one or a duress one can be given by a voter to a third party. The PIN code required can be one that allows other things to be done, thereby discouraging voters from providing such codes simply for the purpose of allowing someone else to vote for them. The PIN code can also be required during the voting, perhaps even at an unpredictable time, making it so that the voter has to supply the code to a third party or be available during the voting.

Typically for mail-in situations, the user would sign or provide a fingerprint and/or other authentication on something received, like that received with the ballot, and return it by mail. This can be done while including the serial number of the ballot. To enforce that this takes place after the ballot is cast, some result of the voting, such as codes revealed, could be returned with the authenticator. A physical thing that has to be returned is even harder to arrange for, such as a self-erasing ballot or counterfoil, as will be discussed later.

A code can be learned by the voter interacting with a center and/or the trustees, and this code would then be used to authenticate the votes cast. But by arranging that there would be no enduring authentication of the code itself, the authentication would have to be done in the presence of a third party for that party to obtain confidence in the vote. An example of no enduring authentication is a code that is obtained over the telephone. An example, without limitation, of such a technique is where the voter chooses a series of challenges, and for each the center responds with one of the valid responses that is tied to, say, a single digit of the authenticator. In this way, the center can choose the authenticator as a sequence of the symbols supplied, but the voter knows that the center is really involved in the selection because of its knowledge of the codes.

One advantage of self-shredding ballots, described later, is that the vote is not revealed by the used ballot, so that a properly used ballot cannot later simply be sold or used as evidence of how it was voted. Of course copying or photographing the ballot, or the act of voting, can provide evidence of how the vote was cast.

When PIN codes are used, a variant of the code or even a special independent code can be used to send a “duress” signal or other message to the system, perhaps secretly.

A ballot can be made difficult to authenticate. For instance, a two part ballot could only work if the two parts that are supplied together are used together. Mixing parts between ballots would make the combinations invalid, but this would preferably not be acknowledged by the system and the user of the ballots would have to trust the supply path through which they were obtained.

Some elections have multiple contests and some election rules allow voters to choose more than one candidate in a contest These are accommodated by the present techniques, where different parts of a ballot contain different contests and at least some contests allow multiple challenges to be provided.

There are various rules for selection of candidates within contests, examples of which include: vote for one candidate (e.g. plurality voting); vote an ordering of the candidates (e.g., instant runoff voting); vote candidate pairs (e.g. Borda voting); vote a subset of candidate (e.g. approval voting). When order counts for multiple candidates, a challenge and response for the first choice (either corresponding to the candidate, ordinal position, or from a list, e.g.) could be done before that of the second choice, and so on. When order does not count, a single countersign can be used to indicate the cardinality of the vote, and an intermediary can optionally permute the order of the votes. Techniques applicable when order does count can, of course, also be used when it does count. Preventing “overvote” and enforcing the maximum number of candidates for the contest can be accomplished by trustees controlling the number of countersigns issued. If the permutation of the candidates relative to the code positions, the so called shift, is a cyclic shift, then the distance between pairs of candidates is preserved; while this may be acceptable in some applications, it can be preferred in others to use a general permutation instead of cyclic shift. The term “shift” used here can be interpreted as also including a permutation when appropriate.

A “ballot” is an article of manufacture that communicates secret information from trustees to voters and that provides the confidentiality and/or authenticity of the information.

Special votes can change the state associated with a ballot, such as the ballot style, when voting of it is started, if it is cancelled, and if it is committed to.

In the input to the trustees, each ballot identity can be regarded as having a state associated with it. The basic state simply reflects which contest(s) have been voted so far and which not. Additional states offer certain advantages. These states can it is believed be divided for convenience in description, but without limitation, into three categories: “front,” “middle,” and “end”. The front states relate to the period before which actual contests are voted by the voter, the middle states are related to the actual voting of contests, and the end states are intended to come into play once the actual voting of contests is completed. With multiple contests per ballot, there may be more than one series of each type of state. For convenience in description, a distinction is made between “control votes”, being those cast by a voter but not for actual candidates, and actual “contest votes”, being those that are for actual candidates that are the subject of the election.

Front states can take various forms. For instance, an “opened” state can be required to precede any voting of actual contests. One example use is a control vote to tie a ballot to a particular ballot style or meaning of the contests, such as when a ballot may be associated with a particular ballot style by being combined physically. Another example use is where the serial number is contained within the vote number for this vote, which may be a control or a contest vote, causing a communication session to be established, and subsequent vote numbers not including the serial number. The serial number may be regarded as “out of band” identification information, other examples of which are the contest being voted, in some embodiments as already mentioned. Another example way to view a serial number combined with a contest vote is as a combination of front and middle. Middle states can enforce limits on contest votes. For instance, the number of false attempts to vote a particular contest can be set at, say, for instance, three. Then the middle-state associated with such a contest will in effect count the failed attempts to vote that contest and, if the number exceeds the limit, three in the example, then that contest can be blocked or the rules can, for instance, stipulate that the entire ballot enters a blocked state. It should be noted that, within limits, control votes can be used while keeping a ballot in the middle states. For instance, a “reset” control vote could be associated with a particular contest and could allow the vote for that contest to be changed. To the extent that codes being replayed by an adversary is considered a threat, restrictions can be imposed on the number of times that a code, such as reset, can be repeated. A “double-check” rule, which may be preferred in some settings, would require that each of two candidate codes be provided in order to select the corresponding candidate. Restrictions on the order and relation to other state transitions may also be desired. For instance, the double codes may be required in a specific order and/or they may either be required to be adjacent to each other or to be in the same place in the whole sequence of votes that must be repeated.

Final states can allow control votes to influence the disposition of the entire ballot. For instance, by choosing to confirm a ballot, by a control vote for the purpose, the voter may make the ballot in effect irrevocable; but, by choosing instead the revote option, the voter establishes that the particular votes cast for this ballot should not be counted and that the voter wishes to obtain a new ballot. Another option is in effect an abstention, no contest votes cast, but a final closing of the ballot. A generalization, as another example, is where the number of votes cast determines which contest should be voted with an end control vote.

A serial number is a unique identifier for a ballot that is used to associate actions related to the same ballot, and the values need not be in any particular sequence or ordering. In some embodiments, the serial number order can correspond to the physical order in which the envelopes are delivered to voting locations. In particular, envelopes may then be divided into divisions such that all envelopes in a division have the same prefix, easing the task of establishing/communicating the exact serial number during voting.

The serial number can optionally be hidden and part of what is read. In some embodiments the serial number can be part of the vote codes that are read, so that it is communicated as part of the reading of the codes, such as by a barcode reader. The serial number can, for the purposes of various embodiments, be considered to identify a contest within a ballot, and the serial numbers for the ballot can in such cases optionally be related. The particular contest being voted can, in embodiments with serial numbers for contests, be hidden, as a part of the serial number can be, from at least intermediary/relays and preferably be computed by the trustees acting together from coded indicia identifying it. For example, a barcode can determine the contest and candidate, but reveal neither to the reader. One advantage of such embodiments is that the reader can be kept from learning the potentially sensitive voter information regarding which contests are voted.

The serial number phase can be skipped in some embodiments, or it can be used to create novel advantages. If traditional controls are in place to ensure that only registered voters can get a ballot and only one ballot, then the serial number agreement phase might not be necessary, unless some exceptional circumstance arises. And tying identity to the serial number might not be required.

When ballot submissions are in multiple parts, as will be described, some or all may be serial numbered with the same or different numbers. Serial number on different parts can be apparently unrelated, with the mapping that brings them into correspondence known to or computable only by certain entities, such as the trustees, as mentioned already. In other embodiments, distinct serial numbers that are related may be readily verifiable as related, for instance, by way of having a pre-arranged common segment. For instance, the first 10 digits might be identical by convention, but the remaining 6 digits could apparently be unrelated. Accordingly, the ability to produce the complete serial number of one document from one that is related can derive from an ability to produce the apparently unrelated parts. This ability might be reserved for those with access to certain data, such as the trustees, or it might not need to be used since proposed values can be checked once the forms are inspected.

If the voter must, in order to choose a valid vote code among some that are invalid, match countersign information to that printed corresponding to a valid vote code, confidence is increased that voters verify countersigns. Thus, the system can be structured to prevent lazy/impatient/yielding voters from never checking countersigns and being fooled into believing that their vote has been counted when in fact it has not. (Other ways to achieve somewhat similar results are, for example, by accounting for ballots issued and/or printing the countersign on the counterfoil.) More generally, if the possible actions of the voter that are considered valid differ because of the particular countersign supplied, then a system may be called “interactive”.

Some interactive schemes allow both the voter and reader to know that the next countersign represents a final commitment and if the code that results in that countersign is not supplied, there is no commitment and the votes are not counted. Such schemes run some risks due to malicious readers/intermediaries and/or lazy/impatient/yielding voters. For example, a lazy voter may not take the trouble to check the final countersign and the reader may take advantage of this to try to stop the voter's vote from counting. Such a malicious reader might, for instance, in a way that might depend on what the reader knows about the voter, not send the code in and pretend to have failed at this point or display a totally wrong value. Or a reader might delay sending a code in until the voter seems to be persistently looking for the countersign. Similar threats may be perpetrated by someone with only the ability to manipulate communication with the servers, whether or not readers are used. Also, it should be noted that fooled or even potentially fooled voters in such schemes not only put their own votes at risk but also reduce overall confidence in the election results. Moreover, there may be little in practice that voters can or are willing to do if they detect such malicious behavior.

An example inventive solution to these potential problems results from an interactive scheme that can terminate after a number of interactions unpredictable to a reader or eavesdropper, but which will be known to the voter, preferably only once it is too late for a lazy reaction. In an interactive scheme the voter is supposed to verify codes in order to learn with certainty which code to respond with, and if during a sequence of such challenges and responses a particular countersign is received that is marked “final” or whatever equivalent on the ballot, the voter will know then and the reader or eavesdropper can substantially only find out for sure after this. For example, the voter is to match the countersign to one of a set of countersigns and respond with the vote code corresponding to the matched one; but, if the voter finds the countersign is marked as final and not requiring any further code, then the voter can stop and be confident that the vote has been lodged.

With unpredictable termination, the chance that lazy voters will not be counted can, as a feature of the system, be made substantial and thus lazy behavior would be discouraged. And this should make displaying/providing no countersign or a false countersign a strategy that will be as readily detected by voters-and presumably roughly as unacceptable to voters-as just breaking off the protocol at any earlier point. Moreover, it is believed that in such schemes malicious parties cannot use a strategy of delay to significant advantage.

One example kind of challenge and response arrangement in accordance with the teachings of the present invention, called a “passive ballot”, uses responses not initiated by corresponding challenges. As an example, the voter is provided (in a way apart from a ballot card) with at least a response code associated with a candidate of a contest. The voter has at least the option to consult a ballot card to verify that the particular candidate and response code are in fact associated with each other. The response code can, however, in some optional embodiments, allow the voter to determine a code to supply.

Verification by the voter can, for example, be done at the time the choice of candidate is made and provided by the voter, such as, for example, at so-called “Direct Recording Electronic” election devices, such as those with included touch screens or other user interface input/output arrangements. Such verification can, for example, be done after more than one candidate has been selected and optionally edited. In yet another example, verification can be done by third parties, a substantial time after selection is made by the voter, using printed records of the responses that were placed in a ballot-box like container.

In passive verification systems, servers/trustees provide response information responsive to submitted choices, but without a challenge. Instead of the challenge, servers/trustees can obtain authentication from an intermediary. One example of intermediary authentication, without limitation, is a digital signature made by a voting machine at a polling place. Another example additional thing that trustees/servers may require is a “begin” challenge code to open the session for a particular ballot, such as, for example a passive one. Before a ballot is counted, in some example systems, a challenge and response interaction can be required to close the ballot. A ‘begin’ challenge and a ‘done’ challenge can be required to be within a pre-arranged time limit and/or a time limit related to other things, including, for example, the timing of the individual interactions.

When a passive ballot verifies votes for more than one contest at a time, as will be appreciated, the choices can be accumulated by the intermediary and be supplied to the servers/trustees as a batch. One example option in such a case is that voters can edit their choices until the batch is submitted. Well-known so-called “radio button” user interfaces, for instance, allow changing of choices that can include “none of the above”; alternatively, an explicit cancellation of a choice can be indicated, such as by selecting again in the same manner as originally selecting or in a different and/or special way. Another example option with accumulated choices is an alternate display in a consolidated or summary form, optionally providing the option to edit again or cancel. A further option, without limitation, is to give the voter the ability to determine when the batch is sent, such as, for instance, by a “submit choices” selection. It will be appreciated that, compared to single votes, batches can be more efficient and with them longer delays can be more tolerable.

(Non-passive use of batches may not allow changes but can hide the choices from the relay and benefit from the efficiency and single delay; the codes voted can be incomplete and require a submit code to be used, protecting a voter who walks away before completing; count verification can then be provided to the voter, as described elsewhere here.)

Response information obtained by an intermediary can take various forms. For example, it can encode symbols that are displayed to voters, such as numeric codes. As another example of many possible, response information can encode positioning coordinates and ordering information, such as the location and permutation of candidate names randomly placed on a page. Other examples include, color, graphics, orientation, alignment, and other visually perceivable phenomena that a voter can identify as matching/proper or not. Transparent, translucent, and/or otherwise optically transmissive media, such as papers, treated papers, vellums, plastic sheets, various laminates and so forth, can be overlaid on a display to allow for convenient/effective verification of correspondence by voters. For example, without limitation, voters can see light transmitted by a display device through a translucent piece of paper and/or verify correspondences by reflections seen through transparent or cut-away parts of a printed form.

Response information can also result in verifiable printing. Paper or other media can be formed to contain chemicals and structures arranged in a secret pattern on the media, using the applicable techniques disclosed here for ballot card printing, for example. To develop an acceptable image on such media, a printing device should have to apply the right chemical-agents/temperatures/radiation in the right places so that a desired or visually acceptable or verifiable image results-determining where to apply what should require information about the secret pattern. Such techniques are generally applicable to document security and control where a centralized system is to control what is printed on special media at remote/unsecured locations. Examples without limitation of chemical combinations that can be used are inks, ink removers, secret inks, secret ink developers, disappearing inks, slowly developing inks, and dies or contaminants that are triggered/released/activated by incorrect agents. Micro-structures, such as microencapsulated agents whose capsules are dissolved by particular agents, temperatures, or radiation are other examples.

Another example use of a printed ballot form is for the purpose of supplying write-in candidates, as also described elsewhere here. The passive ballot form can in one example contain space for write-in candidates, such as by including space for an office/contest and the candidate name. If write-in candidates are to be provided by paper, then it is preferable that all voters provide similarly appearing paper, so as to protect the privacy of the write-in. A response code from the servers/trustees written along with the write-in can serve to identify it and provide verification that the write-in does not constitute an overvote, as also mentioned elsewhere.

It will also be appreciated that saving ballots in general, including passive ones, in a ballot box so that they can later be audited and/or verified has advantages as far a document security. In particular, it is believed easier to fool many voters with a counterfeit ballot than to fool an auditor who inspects the ballots in a box and who uses, for instance, laboratory equipment and/or microstructure information databases.

The mapping between candidates and codes can be printed on a scratch-off so that the scratch-off is typically destroyed in obtaining at least some of the numbers, thereby destroying the link to which candidate was voted for, even to someone who overhears voting and obtains the ballot afterwards.

The “correspondence” between vote numbers and candidates can be indicated in a variety of ways beyond simple juxtaposition, including by “linking symbols”. An example of a linking symbol is a line and/or arrow that connects the candidate and the corresponding vote number. Another example type of scheme is where a symbol, for instance “I” in a circle, would be printed twice: once next to a candidate and once next to the corresponding vote number. One example is where the symbol near the code is considered the linking symbol, but either or both could in some embodiments serve as linking symbols. There are many other examples, for instance, including various graphic devices to make the correspondence easier to recognize, such as using a unique color for each symbol-code pair or using different types of line patterns.

The linking symbols can be formed on a ballot layer or part that would typically be substantially damaged or destroyed when a voter removes the ballot in order to read all or part of a vote number visible below it. For instance, latex, such as that used in scratch-off lottery tickets, does allow printing on its outer surface, but this printing is substantially destroyed when the latex is scratched away to reveal the numbers below. The term “destructible” layer will be used here for clarity and will apply broadly to any layer or structure that bears information that is then substantially destroyed and/or rendered unreadable in order to reveal additional information, with latex as an example.

It may be desired to induce voters to destroy all of the linking symbols. If they were to destroy only part of them, then it may be possible under some circumstances for partial information about the choice made to still be determined by an adversary. One way to destroy all the symbols would be for the code portions under the latex to be distributed under all of the linking symbols. And all of these symbols could be required to vote for any candidate of the contest; that is, the vote codes for the contest would all contain the same segment, such as a prefix, of digits and these would be found under the latex. A variation would provide, under a linking symbol, plural code-fragments, one per candidate, with the fragments coded, such as by color, to indicate which candidate they apply to. Another example would be a two-out-of-three scheme, where only the symbol appearing twice should be uttered by the voter.

A PIN code can be communicated using a scratch-off card in a way that will substantially hide the code from someone who obtains the used card, even if that person has overheard the communication of challenges and responses. Such a card could be used for various remote authentication purposes not limited to elections. Application examples can be found where PIN codes or passwords are or can be communicated, such as for online access.

On the top of the scratch-off medium, PIN code digits (or other password components) are printed. When the user selects such a digit, it is scratched away and the codes below it are used. By not having each digit appear in a predetermined multiplicity, but rather a substantially or practically random multiplicity, someone obtaining the used card is would not be able to learn much about what digits were used, let alone the order. Someone who knows the challenges and responses communicated and obtains the used card, would know substantially the order in which the spots were used, but would presumably not know the digits corresponding to the spots.

Retaining paper records of each vote can be a requirement imposed on a voting system. One example approach to meeting such requirements involves a reader that makes marks on a ballot, as mentioned elsewhere. Another example approach is scratch-off that leaves a record of the candidates chosen. No matter how a record of the vote is developed, the act of shredding of ballots in such systems would be replaced by the act of retaining ballots, for instance in ballot boxes or the like. (As will be appreciated, there are advantages to retaining ballots in many systems, as also mentioned elsewhere here; but retaining a ballot that readily identifies the voter and the votes can be problematic.)

A ballot that contains all or parts of the vote codes under a scratch-off layer or the like, requires that the material be removed to reveal the code. If the voter only removes covering corresponding to one candidate, then an unambiguous record of the vote would be left. In case it is desired to discourage voters from scratching away portions corresponding to non-voted candidates, printing information that at least may be required on top of those regions is believed to offer advantage. Thus, a voter would have to memorize or otherwise note such information.

A potential problem with retaining complete ballots, including at least voted candidates with the corresponding challenge and/or response numbers, is that the order and exact time of casting ballots would be known. This could allow linking of ballots to voters, which is generally regarded as undesirable from the perspective of secrecy of preference. It should also be pointed out that so called “on demand” printing of ballots and/or even very finely divided ballot styles and/or specially made or observed markings on ballots, can all be used to link votes to voters. One example approach, in accordance with the present invention, to addressing this would be that the codes would at least be separated from the rest of the ballot.

For example, with a supplemented ballot, the part bearing the codes could be detached. Or, as another of many possible examples, the single self-contained ballot could be separated into parts, preferably with a middle section that is removed and destroyed, to hide the linking by matching microstructures. The printed ballot, including whatever ballot styles, languages, graphics, candidate rotations, and so forth could-be retained, while the part with the-codes could be destroyed. Complete audit and/or statistical sampling of the retained printed ballots can be used to verify the ballot styles and/or rotations specifically, which may be a particular concern when local on-demand printing of ballots is employed.

When the forms used by a voter are in multiple parts, some may be destroyed, some may be carried away by the voter, and some may be kept in ballot boxes. Some example combinations are given elsewhere here. Those parts that are kept can be required to be placed in multiple boxes, or multiple kinds of parts can be placed in the same box. Furthermore, envelopes are in elections a known way to, among other things, combine multiple parts into a single submission. A device could automatically separate, such as by shredding a slit, a properly oriented ballot that is inserted into it. Some parts can be optional, such as in the case of write-in forms or slips.

There can be advantage, in some settings, to at least some ballot parts having serial numbers. When multiple serial numbers are visible to those at the polling place, they can be linked together by, for instance, being barcode scanned in as related. A serial number on a supplement, when the serial number is tied to voter identity, as described elsewhere, allows the choice of ballot style to be verified later in an audit as being in accordance with what is required for the particular voter.

For non-attendance voting, as an example, a form could be returned by mail or whatever means and could combine the function of providing authentication of the voter, such as with a biometric and/or authenticating information, with the function of authenticating the ballot form used allowing verification afterwards of its correctness, both as also described elsewhere. A serial number and/or the voter information can be used to tie to the remainder of the ballot.

A PIN code can be communicated securely from the voter to a server(s) using a matrix of challenge and response values. A matrix can be re-used, but if digits repeat, multiple matrices are preferable.

So called “PIN” codes are often sequences of 4 to 6 base 10 digits known to consumers and used by them to authenticate their identity. In elections, authentication of voters as registered can be important and a PIN code can be used for this purpose. Thus, a voter would establish a PIN code with a registration authority, for example by being given a code generated by the authority. Other ways to establish codes are applicable, such as by using all or part of an existing number associated with the voter, and/or allowing the consumer to change or even choose the initial code themselves. It may be desirable for single codes to be used for multiple elections and also multiple and/or other purposes. Particularly when codes are to be re-used, security is believed enhanced by keeping the codes confidential from adversaries during use.

An example way for a voter to communicate a PIN code to a registration authority (or other entity or entities who may jointly or separately verify its validity) is using control votes. A first digit of the PIN code would, for instance, be voted first, followed by a second, and so forth. The digits would, in one embodiment, be arranged in a two-dimensional pattern familiar to voters, such as the layout of telephone keypad. It is believed that different patterns are familiar in different parts of the world and that in some places additional information, such as various assignments of letters to digits, is helpful to consumers. Moreover, there are many other possible schemes, such as letters of an alphabet or other symbologies. Permuting the placement of symbols from a familiar placement and/or ordering is an option that, as in other circumstance, would preferably be chosen after weighing the threat of observation of voter actions against whatever inconvenience and trouble the unfamiliar order may cause.

In one example embodiment, codes can have multiple occurrences of the same digit and a different matrix is used for each successive digit of the PIN. Thus a four digit PIN would require four matrices, the first for the first digit of the PIN, the second matrix for the second digit of the PIN and so on. In other embodiments, such as where the PIN digits have been chosen to not include repeats and/or where other factors predominate over the security issue posed, a single matrix would be preferred. One natural example embodiment provides that the digits are selected from the matrix successively and in order. In some settings, particularly where automated reading of the codes is expected, instead of multiple matrices, a single matrix with multiple vote numbers per cell yields compactness and familiarity for voters. When a reader is used, in some embodiments, it may see multiple values at once, and be programmed to provide only the first code the first time a cell is selected, the second only when the cell is selected for a second time, and so forth. Even though some such arrangements allow readers to change codes, readers may still receive little information about the code itself.

In some cases, there should be provided a way for voters to write-in a candidate that does not appear on the ballot. If voters have to place a slip in a box only in the case that they write-in a candidate, this reveals something about their voting to those in attendance, as mentioned. In case ballot forms are retained for audit, described elsewhere here, the write-in could be made on such a form. If there is no corresponding electronic vote, then some voters may overvote by both writing in a candidate and casting an electronic vote, and it may be difficult to separate such overvotes from the proper ones.

An example inventive solution in accordance with the present invention is the use of a “write-in code”. Such a code can appear along with the other codes on the ballot but would not be provided to the servers by the voter. Instead, the write-in code would be transferred, such as by being written or by the voter moving a self-adhesive element, to the form that does not contain the codes and would not be destroyed. To make the write-in code valid, the voter should vote the corresponding candidate placeholder indicated as write-in. Then, when the actual written-in candidates are being counted, the write-in code next to each would be verified. One way to verify such codes is by checking their presence on a list published by the trustees. Another example way would be that the codes are offered to the trustees and trustees cooperate to verify if the codes are valid.

Such codes can be computed by the trustees with or without revealing the serial number. An example way that reveals the serial number, when using some example counting systems, would be to trace backward those ballots in the final output that are voted write-in. Tracing backwards is accomplished by each trustee, in reverse order, showing which of their inputs yielded the particular outputs.

To reveal valid write-in codes without revealing the serial numbers, the write-in codes would be computed by the trustees in serial number order but left multiply encrypted, one key for each. During phase two of an example counting system, these values accompany the corresponding ballot pairs through the permutations. They are also decrypted and re-encrypted, as with ballots of the example counting system. Those that end up being paired with ballots voted write-in can be opened by being sent in a special batch through all the trustees again, this time each trustee removes its remaining encryption from all items in the batch. The output of this process is the batch of write-in codes in, for instance, the same order as the other output ballots.

A way to accommodate requirements for write-in candidates that allows the trustees to process the choices automatically much as other votes is referred to here as “type-in”. A type-in ballot can, for instance, include alphabet entries as candidates which voters can successively choose. Printed or otherwise established abbreviations for candidates that may be written-in are preferred, not only as a convenience for voters and a way to streamline processing, but as a way to eliminate ambiguity caused by misspelling.

In embodiments where there is a choice between write-in and preprinted candidates, it can be desired to protect the privacy of a voter's choice between these two, as also mentioned for write-in voting. One way to achieve this with type-in ballots is for the intermediary to pad out all votes to include a standard number of codes that serves as the maximum length of a type-in name. Another approach is to require or optionally merely to allow pre-printed entries to be entered by the type-in approach, again with a fixed length of symbols.

If the total number of write-in's is below some threshold, such as that which would be needed by a single candidate to win at least something, then counting of the type-in votes can be deferred, if this is in accordance with policy, until after the determination that enough have been cast. When write-ins are to be distilled from the ballots, the relevant ballot part would preferably be treated by the trustees in a way that would result in a list of write-in candidate names as spelled. This can be achieved by considering a ballot part that has type-in as a contest in which there are multiple candidates and candidate order is important. Candidate order can be left out, under the theory that a write-in that is sufficiently interesting can have a unique set of letters in his/her/its name.

The “production” of physical ballots is any way to produce the physical ballots that contain and hide codes used to enhance security of the voting system.

Printing by multiple independent mechanisms can be arranged so that of all the mechanisms is need to learn how voters vote. During printing of ballots, the same pieces of ballot paper or the like can be printed successively by otherwise independent printers. The printers may work on long rolls of paper, such as with web fed, or on smaller sheets. In some embodiments, one printing is completed on many ballots that are then transported to another printer at once. In other embodiments, the feeding of sheets or roll stock passes through more than one printer in series. An example way, of many, to provide synchronization of the printing would be that each printer has a reader that can read a serial number on a portion of the ballot but which is preferably unable to read what other printers have applied.

If the linking symbols, as described elsewhere, are provided by one printer and the rest of the ballot by another printer, then it is believed that both would have to be compromised by an adversary in order for that adversary to know how voter utterances correspond with actual votes. The choice of linking symbol, to be printed by a second printer, would be responsive to the appropriate shift value; the vote codes themselves, printed by the first printer, would be unchanged. If the linking part were destroyed, then the other part could be shown, kept for audit purposes, or even made public.

A further and combinable variation would use any number of printers. Each printer would receive a full set of different codes. The voter and/or reader would form an addition, modulo the appropriate value (or some other combining operation designated, such as a group operation) to re-combine the codes and/or linkings.

In some embodiments, printing by one printer cannot be read by a later printer. One example way to achieve this is by applying a hiding layer, such as scratch-off latex, by a previous printer. Another example way is by printing through a hiding layer, such as by activation of inks or other compounds on inner layers, such as by heat, force or particular kinds of electromagnetic radiation. For instance, heat developing inks are known, microencapsulated compounds are released when crushed, and ultraviolet light is known to induce certain reactions.

Other embodiments use separate enveloping techniques per ballot part and then these are collated together at some point before voting. For instance, each of two parts could be produced separately and the voter could then choose and/or be given one from the first stack or hopper and one from the second stack or hopper. Another example, one of many possible styles of collation, would be automated and accomplished with un-enveloped ballots and result in collated sets within a common envelope.

Ballots, in the examples described here, will comprise a card that is contained within an envelope that hides at least the code indicia on the card. In some configuration, called “self-contained”, the card will contain all the voter needs to determine which code corresponds with which candidate and which contest; the card itself would be enough for the voter to cast the desired votes. In other configurations, called “supplemented”, additional indicia would be provided to the voter to allow the voter to determine which code corresponds with which contest and candidate. One common form of supplement is used in the so called “Votomatic” system, where ballots are divided in pages that are crimped into metal brackets that allow them to be turned like the pages of a book. Votomatic provides registration guides including alignment pins and a slot into which a voter inserts a card during voting. Different portions of the Votomatic card are then visible between each pair of facing pages when those pages are open.

Another type of supplement, not in such widespread use, is where the card is positioned substantially in a predetermined position relative to a printed instruction sheet. This could be accomplished by the card being adhered to the instruction sheet after the voter places the card in position marked on the instruction sheet and the two being held together such as by adhesive pre-applied to one and/or the other parts. In poling places where different voters may require different ballot styles, such as because of where they live and/or what party they have registered for, supplements can allow practical flexibility, since they can even be printed on demand. Another example, of many possible ones, is where the card and ballot are positioned relative to each other in a pre-determined manner, such as being laid side-by-side, with or without alignment devices/indicia.

One use of a front control vote is to link to the ballot style of supplements. Those systems where the ballot is associated with the voter in an automated way can allow the proper ballot style to be determined from the voter information, even for self-contained ballots. But a way to ensure that the ballot style of the actual supplement used matches that which is expected for a card is for the voter to in effect vote for the ballot style; that is, a ballot style contest would include various candidates, one for each ballot style or certain subsets of candidates might correspond to a style. The voter would vote the style as a control vote.

One example way to indicate a ballot style would be similar to the way a pin code is entered, as described elsewhere, in which multiple candidates are entered to encode a ballot style number. In some embodiments, an actual unique indemnification of the ballot form, by a kind of serial number printed on it could be voted by these techniques, tying to the actual form. This last technique, can among other things, be an aid to ensure that write-in votes, also mentioned elsewhere, do not contribute to overvotes that are hard to keep out of counts.

A number of contests can be combined on a ballot and/or a partition by multiple ballot forms. In particular, various ballots for middle votes can be bracketed between the same front and end votes. Also, as will be appreciated, different types of ballots can be used in the same election. For example, self-contained ballots could be used at a polling place, while supplemented ballots would be held in reserve at or near the polling place in case the need for ballots were to exceed the supply of self-contained ballots. Such supplemented ballot reserves can be retained and used over a period of time for multiple elections.

The type of visible indicia for candidates might, instead of being a letter, include photographs of candidates, icons, symbols, text and/or colors. For challenge and response, any visible indicia might be appropriate, such as words, syllables, letters, symbols, icons, colors, and so forth. The actual correspondence between indicia and candidates might be indicated by external signs or messages, in case they are not recognizable from the printing. Suitable indicia for serial numbers might include any of the above means. For those parts of ballots intended to be read primarily by machine, more compact and special symbologies such as barcodes and so forth are appropriate. Redundant symbologies allowing both ready human and machine reading are also applicable, and can have advantages in allowing voting even in case of equipment failures. Certain codes, however, should be kept from being easily read by machine, but can be human readable, as mentioned elsewhere.

Instead of a sequential ordering of the shift positions, other fixed orderings or even arbitrary permutations can be used, as already mentioned. These can, for instance, be encoded as according to a numbering. The size of the challenge and response could differ from each other, and they might be small or larger. For instance, with multiple races, the checking done for each race would contribute to overall confidence, and the individual response sizes could be smaller. The challenge needs to be large enough to encode the candidate, but some redundancy helps prevent the relay from changing the vote. An example way to combine multiple races for increased confidence but with small challenges or responses would be a table with rows and columns labeled by different candidate codes and entries constituting combined responses and/or challenges.

In addition to the challenge and response per candidate, already described, a single initial countersign would allow the voter to know that they are indeed in communication with the trustees, before they begin giving a challenge. In one variation with two candidates, one of two confirmations arrive, and the voter answers with the corresponding challenge for candidate ‘A’ and the other challenge for candidate ‘B’. Of course the response may not be used in some elections.

Location of candidates on ballots can be revealed safely in some applications. When voting in public and only hiding what's printed on the ballot, the motion of the eyes might reveal which place on the ballot the voter is looking when reading a vote code or verifying a countersign. If these positions were to correspond to the same candidate on all ballots, then the choice of candidate could be revealed. For this reason, the location of candidates on the ballot has been permuted. However, when voting without a reader in a booth or wherever eye movement cannot be observed by others, such re-arrangement may not be needed. The re-arrangement can prevent or at least make it difficult for a reader that is sensitive to motion or position to learn the votes, particularly when the ballot is held stationary, even if the reader can only see things that are up close. The ballot printing apparatus can print the candidates within a contest either in order responsive to the vote codes supplied the printing apparatus, hiding eye movement, or in order of the candidate symbols, providing uniformity of candidate placement. While the positioning can be randomized by the printer, with or without input from the trustees that can be audited, the remainder of the election process is essentially the same.

Opening of a random selection of ballots can detect various problems. If a ballot printer were to change the shift amount on some ballots, then when those ballots were voted, the tallies could be wrong. One way to detect such changes would be for some ballots to be opened. A random selection of ballots, or at least a selection that could not be controlled by those preparing the improper ballots, would provide a certain probability of detecting the improper ballots. One example way to open ballots is for auditors to vote them in a controlled way. Another example way would be for the content of the ballots to be made public and for the trustees to each supply otherwise secret data, specific to those ballots, that went into making that trustee's contribution to the ballots. If these trustee secrets are committed to by the trustees in advance of any audit, such as being encrypted with so-called “blob” or “bit commitment” schemes, then the secret keys allowing the commitments to be opened would allow the auditors to verify that the printing was performed properly.

Yet another example way to provide auditing, from the many possible example ways, would be to print on each ballot secret trustee information that would be sufficient to verify the trustee commitments. In still another example, digital signatures by the trustees on their respective shift amount contributions can be printed on the ballot. While the signatures are believed somewhat less secure than the published commitments, they have the advantage of local and autonomous verification, and the two could of course be combined. Since this data would be available to the voter of the respective ballots, it may be desired that the data cannot be used to show how an actual voter voted to someone who knows the voter's utterances but does not have access to the physical ballot, perhaps because the ballot was shredded. One way to prevent voters from being able to prove to third parties how they voted using these numbers would be to encrypt the numbers, although this is not believed highly resistant to abuse and not that advantageous compared to having the trustees provide the numbers. Another example solution would be to rely on the encryption of the utterances by readers/intermediaries.

A simple approach might be for the triples to be printed on a piece of paper or cardstock, possibly with the serial number on the back, and this would be inserted into an aluminumized Mylar envelope that is welded all the way around and possibly embossed with holograms. What has been refereed to as an “envelope” here, need not be an envelope in the ordinary sense at all. For instance, a single piece of card stock could have known scratch-off or pull-tab hidden triples on one side and a serial number on the other side. Also, part of it might be able to be torn off to server as a receipt. The receipt in general may or may not include the serial number or part of it. A simple envelope with a slip of paper in it could also serve, assuming it has adequate security against being surreptitiously opened or seen through. A single piece of stock could also be folded and affixed to conceal codes. Ballots could be grouped and packed in envelopes, bags, or whatever that include additional tamper-indicating mechanisms.

Some data displayed might fade and become unrecognizable over time, due to the act of opening, for instance because of the effect of light or air or because micro-encapsulated reactants are released by rupturing during opening. Shredders or chippers could be provided with transparent housings, containers of solvents or corrosives could be used, and/or incineration might be employed.

As stated earlier, “trustees” sometimes also referred to more broadly as “servers” cooperate at least in some combinations and/or through functionaries and/or machines. The function of one or more trustees, however arranged and constituted, is to provide trusted use of secrets, and/or trusted storage of data, supportive of the overall functioning of at least some aspects of a voting system.

A single entity may fill the trustee role, or it may be filled by a collection of parties, such as individuals, private-sector organizations, or parts of government. In the latter case, a simple unanimity scheme may be employed. Each trustee could have a vault like secured computer or its system could be managed in a more distributed way. In some cases a majority or some threshold rule may be desired among the trustees, in place of unanimity. One way to accommodate this would be for each trustee to secret-share their secret seed, so that in case they are overruled by whatever agreed set of possible quorums, the quorum can get access to their keys and complete the election. This requires that the seed is actually used by each trustee. This can be established through the cryptographic proofs made by the trustee that the values committed to, as described elsewhere here, do in fact bear the required relationship to the seed, which allows them to be readily generated from the seed.

The release of the second fixed exponents by the trustees could be through a known gradual release of secrets process, preventing any of them from learning the secrets of the others in advance of deciding whether to reveal their own. Also, the order that the trustees process items in the first and second pass could differ and might include overlap.

It is generally desired in cryptographic protocols that each party prove to other interested parties that they have completed the part of the computation properly. This is provided for this election protocol. In one aspect, the shift values would all be committed to by each party using, for example, the pair encoding or the like, so that the transformations in the first pass could be proved correct and this commitment could be verified by the printer during printing.

The fixed exponents would be committed to and their application proven. Similarly, the values applied as exponents to both members of the pair of residues comprising the digital ballot need not be revealed, but the fact that the same power is applied to both values would be proven. The permutation and exponents applied to each pair in pass two, for example, can be shown using the know technique of providing a set of secret powers on all the inputs and requiring that those secret powers be shown on.

The “ballot counting” is any procedure that results in a function of the votes, as contained in the digital ballots agreed to be counted, being made known.

In some cases it may be desired to hide the total number of votes cast for each candidate of each contest, while still establishing certain properties of those totals-such as who the winner is. One example way to achieve this is for each trustee to participate in a multiparty computation simulation of the whole ballot counting process with the desired functions of the tallies as the only outputs.

As will be appreciated by those of skill in the art, the example method of realizing the desired basic computation is only and example, which is believed to offer economy and simplicity. But the same general known multiparty computation techniques mentioned above could be used to perform this basic protocol as well. Other less general ways to perform it can use other examples of known homomorphic encryption.

One feature that can be implemented by a multiparty computation, and by some less general techniques, would be that the challenge numbers would not be revealed initially, but rather the result of a test to see if that challenge proffered is on the list would be conducted. As another example, the outputs of multiple contests could be produced in the same order. One way to do this with the present example special protocols is by well known techniques sometimes referred to as “coordinated instances”, in which the trustees would use the same permutation for each of multiple sets of ballots, one set being for each contest. One common example in elections is “straight party” voting, where a single choice indicates a whole slate of otherwise selectable candidates. It may be desirable to hide whether choices were made in this way or individually. When so-called “modified” straight-party voting allows “crossover” for some candidates, such hiding may be even more interesting.

If there is only one entity serving as a trustee, it can just use a single computer to perform the entire function that would be collectively performed by the trustees. It will also be appreciated that a single trustee entity may use more than one server to distribute the trust they need to have over the mechanism.

One example way to form and count digital ballots will be presented here as an example and in a broad summary sketch; more details of this example will be provided later.

Digital ballots will, in an example presented, consist of values in a discrete log system, such as for instance the least positive representative of a residue class modulo a large prime, or as another example, that modulo a large composite with unknown factorization, as are well known. Each ballot will consist of an ordered pair of values, with the power difference between the members of the pair, the power that the first needs to be raised to in order to obtain the second, the so-called discrete log, corresponding to the vote. Each factor of two in the exponent will correspond to a shift in position; the multiplicity of two in the exponent, modulo four in the example, will be the vote in the final output. Values other than two can also be used, but two is used for clarity here.

For the pre-computation, each pair will initially consist of two copies of a generator that is public and fixed. Then, the pre-biasing will raise the second to a power to encode the public position that was revealed during the voting. If the public position is number zero, corresponding to the first position with zero-based indexing, then there would be no bias. If the public position is the second, then the bias would be one; if third, then two; and if fourth then three. Since the serial-number list was the public output of the third overall phase of the election, the output of the pre-computation will be a list, in an order such as serial-number order, of the biased pairs.

During the first pass through the trustees, each trustee takes an ordered list of pairs as input, raises the components to various powers, and outputs a list of pairs in the same order. The input to the first trustee is the output of the pre-computation; the output of the final trustee is the output of the pass. One exponent applied encodes, in the previously described manner, the shift value supplied by the trustee in the formation of the particular ballot. For instance, if the shift value was zero, the exponent would be one and if the shift value were two, the exponent would be four. To hide the value of this exponent in the output, a first secret-to-the-trustee “fixed” exponent is applied, but the trustee uses the same hiding exponent for all the pairs in the batch. A third exponent is different for each pair and is applied to both elements of the pair. It serves to destroy any resemblance between pairs with the same first element.

In the second pass, a second fixed exponent is applied, and the first fixed exponent removed. Again, both components of each pair are raised to the same random exponent, to hide correspondence with the input. The output produced by each trustee would, for instance, be in a sorted order, based on the value of the first number in the pair. This is intended to completely hide the association with the serial numbers and ordering of the first pass.

The post-processing requires that all trustees reveal the hiding exponent that they installed in the second pass. By removing these exponents, through raising the second components to the inverse power, the pairs are left encoding the sum of the position values and shift values applied by each trustee. The possible small exponent values are tested until one fits. (This can be made more efficient if each trustee applies either the exponent or the equivalent root corresponding to the additive inverse of the value to be encoded. Then a search for the correct exponent can start out at one, go to two, then to square root, then four, then fourth root, and so on.)

As already mentioned, a set of ballots, identified by their serial numbers, can be selected for counting/tallying. When this process is repeated with different selections of ballots, of course information will be revealed about how certain ballots voted. For instance, with two tallies a second that is a proper subset of the first, not only the tallies for the two sets, but also the tally for the difference of the two sets is revealed.

The serial-number, challenge and response data can be relayed from the voter to the trustees in almost any way. In some example embodiments, a person can act as relay to the trustees, communicating verbally with the voter, for instance, while supplying data to a computer connected online to the trustees. The relay can be totally automated, such as with a voice response system or video cameras and displays.

A reader is an automated intermediary that can read codes on ballots and/or verify and/or display countersigns and/or establish encrypted channels and/or enforce voting rules and/or provide reminders to voters and/or manage ancillary information.

A reader can optionally verify the countersign received against that printed and provide voter feedback responsive to the result of the comparison. A reader can give, for example, positive feedback comprising a sound, vibration, and/or change in light/display to indicate that the countersign has been received. As also mentioned elsewhere, two or a small number of different feedback patterns can provide some confirmation of a response, where that aspect of the response is indicated by printing not read by the reader.

In terms of user-interface, a reader optionally can noticeably not scan/read/accept the next code until the countersign of the previous one has been verified. One example way this can be accomplished is a mechanical locking mechanism, such as buttons or other actuators, that the voter would normally operate to select a code, that is made inoperable until verification is completed. Another example way is a light or other indicator used in selecting or positioning the reader that is not energized or does not energize until the countersign is received. Yet another example way to give a definite impression is by creating perceivable negative feedback, such as jamming of mechanism, for attempt to cast a vote without waiting for the next countersign.

Further voter confidence can be achieved if one or more countersigns or parts thereof are not readable, and/or are not read, from the card by the reader but are displayed, voiced or otherwise provided by the reader to-the voter for is checking against what is on the card. Some example arrangement for this are presented elsewhere here, including related to interactive ballots and counterfoil readers.

A reader can provide encryption of data exchanged with one or more entities, such as trustees and servers more generally. For example, a public key protocol allows the reader to establish a message-secrecy providing session with a server based on the reader's knowledge of public keys that can be used to authenticate the public key of the server. A private key in the reader allows the reader to provide authentication for messages it sends, optionally by forming a digital signature or another authenticator on such messages. If certain ballots are to be voted from polling places only, then servers can expect the signature of a reader on the corresponding vote codes.

The reader forming the signatures can indicate which messages are related to the same ballot, such as by using a separate session key for each ballot. Once the servers receive vote codes from a ballot signed by a particular reader, the servers can be configured to expect all future vote codes from that ballot to also be signed by that reader. In case of reader failure during voting of a ballot, a cancel code can optionally, and further optionally with extra authentication, be accepted to allow a revote by that voter. Ballots for which vote codes have been exchanged in an encrypted form, and especially those whose vote codes are restricted to be voted through a particular reader, are rendered relatively harmless outside the polling place and particularly once the reader has destroyed any session keys. Thus, in one embodiment, the shredding of such ballots can be optional and might not even be provided for.

To detect readers improperly taken from polling places, proximity of readers can be verified. For example, line-monitoring of their cable (as with burglar alarms generally and fiber optic seals) and/or using onboard GPS and/or with triangulation by wireless communication subsystems, and/or by maintaining continual and optionally timed communication with readers. In some uses, for example, readers would be fixed to, tethered to, or otherwise intended to remain in a voting booth. In other example uses, without limitation, readers are carried by voters. For instance: a voter picks up a reader from a basket when picking up the ballot; at the shredder, the reader authorizes the machine to start up; and then the reader is either returned to the basket or taken for the revote because the reader's revote light is on.

Other uses of encryption are anticipated. For example, data on ballots could be encrypted, so that only readers that receive associated keys can decrypt it. Ballots could contain digitally-signed or otherwise authenticated data to aid readers in assessing the validity of ballots. Techniques allowing readers to read physical signature data, such as dispersions of fiber optics, reflectors, magnetic particles, or paper fiber, and to compare the patterns read to digitally signed characterizations are good document security techniques that optionally can be employed. In some cases, leaving a visible mark on a ballot can be a feature. For instance, voters may use a mark to keep track of votes that they have already cast and/or retaining a marked ballot may be requirement of a voting system. A stylus or wand style reader that is brought into proximity with a region on a printed ballot can include marker means. Example marker means include adapted writing instruments, that wick, roll, or otherwise channel ink to the writing surface. Another known marker technique is ink stamping, such as is commonly placed at the non-writing end of writing instrument. Another example is stylus means adapted to remove scratch-off coatings or the like.

Reading can be performed by video camera, as mentioned, such as using conventional OCR or barcode techniques, for example. Special properties of the reading operation can have advantages. For example, desired in some embodiments might be that at least what is being read is apparent to the voter. In another example, the indicia substantially cannot be read by the reader from distances beyond a threshold and the voter would have to bring the two into relative proximity.

If the reading range is small compared to the physical distance between codes on the ballot, then the voter is believed to have effective control over which codes the reader obtains and when they are obtained. A stronger example is indicia that are hard to read from a distance. Another example property is that the reader marks the item read indelibly. Yet another property is that reading destroys what was read. Examples ways to achieve each of these will now be presented.

Making it clear what is being read can be achieved, for example, with bright spot readers, such as those aimed and/or preferably read using reflectance from light beams such as lasers, as are well known in the barcode reader art. Physical apertures also can perform such functions.

Reducing the range that a reader is capable of can be achieved, for example, with optical detectors by reducing the maximum distance for which focus is adequate. So called “contact image sensors,” such as the ia2008-mb20a made by Rohm, are a well known example, typically used in fax and scanner machines, of optical sensors configured with their own light source to reflect off the paper typically requiring close proximity for reading. Although these contact image sensors are usually a single array of sensors, two dimensional arrays can readily be conceived.

Reducing the range that readers can easily read at, for example, can be achieved by using a part of the spectrum that cannot be focused or readily controlled, such as inductive. For instance, eddy current techniques can be used to measure the presence or absence of metallic properties hidden under an opaque hiding layer.

A barcode reader, using a so-called “two dimensional” barcode for instance, can read a code that is positioned around but not inside a target zone. A reader can be configured so that in order to come close enough to focus, a stylus in the center of the camera view would have to penetrate the surface of the ballot, thereby leaving permanent marks. Inks that develop with heat or other types of energy can be employed in combination with a reader that supplies such energy to leave marks.

A reader stylus that is penetrated through a latex or other hiding layer can read information hidden below the layer from the contact that the sides of the stylus would have with the penetrated medium. For example, the stylus can be configured so that it removes protective layers from the part of a card that is deformed into a cylinder round the stylus. Then the stylus would be in substantial contact with an area of the hidden information, which could be read optically or magnetically, or conductively, for example.

Destruction of data from the act of reading the data has been described for scratch-off coatings that have data printed both on and below the scratch-off coating. Other examples are visible chemical reactions that do not persist, for instance, disappearing ink. Heat or other energy that is used to develop one image and/or mark can also destroy code data.

A “counterfoil” is a preferably detachable part of a ballot form, also sometimes referred to as a “receipt” or “stub”. Typically, counterfoils are attached to a ballot, but can be unattached and/or attached to an envelope. A “counterfoil reader” is a reader for reading and/or printing information on counterfoils. Counterfoils preferably are detached before being read/written by a counterfoil reader. Counterfoil readers can optionally display and/or print countersigns related to exit options. One exit option, for example, is a “commit” to the ballot cast and another is a “cancel” and request to revote. Counterfoil readers can optionally cooperate with shredders, for example, so that corresponding ballots are shredded.

Counterfoils can be attached, such as by perforation, adhesive, or a pre-scored, weakened or partly cut separation, so that the counterfoil can be removed. A counterfoil can contain, for example, a serial number. Another example information content is one or more control vote codes as well as corresponding countersigns. For instance, a counterfoil could bear visible indicia standing for a vote code for committing the ballot and/or a different vote code for canceling the ballot.

The ballot and counterfoil arrangement can cooperate with the counterfoil reader in such a way as to make it at least substantially difficult/inconvenient for the voter to cause the counterfoil reader to incorrectly determine that the counterfoil and ballot are separated when they are in fact not. For instance, the foil-reader can have a slot/area into/onto which the counterfoil is to be inserted/positioned that does not provide room for the ballot or at least not an attached ballot. In another example, and possibly in combination, the potential presence of a ballot could be detected by the added thickness or other sensed characteristics of the ballot. The reader might, as a further non-limiting example, be arranged so that the severed edge of the counterfoil is inserted first into the reader.

One example function of a counterfoil reader is to energize, in the those cases where the counterfoil is detached, a shredder or the like to allow the destruction of the rest of the ballot. If the foil-reader is used to send a confirm control vote and the correct countersign is returned, then the ballot can safely be shredded. Similarly, if a control vote that requests a revote is cast and its countersign verified, then the ballot can also be shredded. If the counterfoil is not valid, or has already been used to shred a ballot, then the shredder preferably is not activated. Such mechanism provides poll-workers/observers with a way to directly ensure that voters destroy their ballots, but not the counterfoils. Also, such mechanism can ensure to a degree that the final control vote is cast.

Conventional paper shredder or other document destruction devices, referred to as “shredders” for clarity and convenience here, can be adapted to the present purposes. As one example, in some applications it may be desired to keep counterfoils from being destroyed by apparatus that is intended to destroy the remaining portion of ballots. The physical inlet opening can, for instance, be shaped so as to not allow the counterfoil to fit. As another example, a shredder can be under the control of a reader or associated logic in such a way that the shredder will destroy, and/or be prevented from destroying, inserted material such as counterfoils responsive to signals from the controlling apparatus.

Another optional example approach is for shredders to read properties of the inserted material. For example, ballot backs may be prepared with a particular color, pattern or other distinctive reflectance or conveniently measured characteristic; a shredder that includes sensors for the special characteristic can be configured to enable the shredder to operate in the presence—or, in other configurations, in the absence of—such characteristics. Accordingly, a shredder may be arranged to shred ballots and not shred counterfoils: characteristics of counterfoils would preferably prevent their shredding and/or characteristics of ballots would preferably allow their shredding. Such an approach can, as an example of an additional feature, require the ballot to be inserted in a folded state, thereby protecting the secret information on the inside from view.

Shredders can optionally be configured to not only read a characteristic but also read information from the documents that they are about to shred. For example, serial number information printed on the outside surface of ballots can be read using well known linear barcode techniques. Such a serial number can then be used in automation of a voting place. For example, but without limitation, a counterfoil reader can enable the destruction of the corresponding ballot once the operations on the counterfoil are sufficiently assured. Similarly, operations on a counterfoil can be kept from advancing beyond a predetermined point until the corresponding ballot destruction, at least to a certain point, is assured.

(It should be noted that in some example embodiments of the inventive concepts disclosed here that some documents are to be retained for possible future verification, as mentioned elsewhere, and that the techniques described here for shredders can similarly be applied to mechanisms such as ballot boxes and/or hoppers intended to retain documents. Moreover, separating those documents that contain write-in's from those that do not can be advantageous.)

Integration of counterfoil reader and shredder will be illustrated by a particular example, but without limitation. The reader can issue protesting user feedback, such as a buzzer, and/or provide instructions, once a counterfoil is inserted, until the corresponding ballot is loaded into the shredder; similarly, protest and/or directions are provided when a ballot is inserted and the corresponding counterfoil has not been. Once a corresponding ballot-counterfoil pair is inserted, and the selected code is read from the counterfoil (as will be described), the shredder may begin shredding, and once the shredder has finished or a poll worker intervenes, the countersign is printed on the counterfoil.

A further example function of a counterfoil reader is to provide the voter with some verification of the countersign corresponding to the final control vote. An example way to facilitate this comprises recording the countersign on the counterfoil in a way that the voter can read the countersign but that the counterfoil reader cannot. Preferable are arrangements in which the inability of the reader to read the countersign is readily verifiable and effective, much as for voter control of readers described elsewhere here. Then, when the foil-reader obtains the countersign from the system the foil-reader can display the countersign to the voter for comparison and/or the foil-reader can print the countersign on the counterfoil for later verification by the voter and/or other parties. Part of the countersign might be checkable by the foil-reader, or other redundancy introduced, as would be apparent to those of skill in the error-detection/correction art, to substantially prevent a corrupted or otherwise incorrect value from being displayed/printed. An example way to temporarily protect at least part of a countersign printed on a counterfoil from a reader is to cover the printed version of the counterfoil with a scratch-off layer. Another example way would be to cover the counterfoil with a thumb.

A selection between plural end codes can optionally be provided. For example, one code for commit and another for cancel, as already mentioned. Selection can be made by inserting the counterfoil into a receiving portion of a reader that corresponds to the selection. For example, separate readers can be provided for commit and for cancel. Some readers can share shredders, others may have their own shredders, and still others may not be tied to particular shredders and/or may not cooperate with shredders. If a single receiving portion of a reader corresponds to more than one end code, the voter may be allowed to select among them. It will be appreciated that the exit state can be selected by out-of-band techniques without using dedicated control votes and their codes, such as by the voter pushing a button and indication of the type of button being relayed to the trustees. However, it is believed preferable to remove the discretion of the counterfoil reader by employing readers that allow more substantial control by voters.

One example counterfoil reader, referred to here as “complete” would contain: two positions for the counterfoil, one for commit and the other for cancel; printers to print the corresponding countersign on the counterfoils; a shredder that reads the serial number of the ballot and is controlled by the reader; and an optional dispenser for new ballots in case of revote. Another example reader, referred to as “split”, performs one of the commit and cancel functions. An optional attribute of such readers, referred to as “separable”, is cooperation with remote, and optionally shared, shredders by providing them with the serial numbers of ballots authorized to be shredded. Still another example counterfoil reader, that may include substantially an ordinary ballot reader, prints a preferably self-adhesive “sticker” that contains the countersign and is readily attached to the counterfoil preferably in such a way that the countersign on the sticker can easily be compared to corresponding one already on the counterfoil.

Biometrics are data measurements made of the human body that are used to authenticate individuals. Examples include, but are not limited to, fingerprints, handprints, hand geometry, speaker recognition, facial recognition, and so forth. Although mentioned elsewhere, here some particular example uses are given with a focus on the biometric functions and resulting features and advantages. A fingerprint from the same finger, such as the right thumb, will be used as an example, but many other suitable biometrics could be used.

There is often a tradeoff or at least a perceived tradeoff, between improved protection using fingerprints and the level of privacy in general and secrecy of votes in particular.

One example scheme is to require that fingerprints be submitted on otherwise unlinkable forms during attendance voting. This will be called “anonymous fingerprinting”. For example, each voter forms a print on a small unmarked slip taken from a hopper and places the result in a second hopper. Later, all these prints can be scanned in, and duplicates identified. If such prints are linkable to the identity of persons, they could be prosecuted. But even if they are not so linkable, the scheme may well serve as a deterrent to voting abuse, since there is a record and the prints may someday become linkable, such as when a person is arrested or applies for certain types of jobs.

A second example scheme is where, as mentioned elsewhere, when ballots are supplied to voters for use outside polling places, called here “non-attendance” voting, voters can be required to provide a fingerprint that is linkable in some way to their identity as a registered voter. For example, voters may send in a form that has an identifying number and their fingerprint. Or, as another example, the form might require that they provide a handwritten signature, personal data, answers to pre-arranged questions, and/or PIN codes and passwords. The finger print may or may not be checked for match against that on record for that person.

As will be appreciated, the combination of these two above examples, one for attendance and the other for non-attendance, for a single election that allows both, can yield unexpected benefits. For example, someone who votes at least once by attendance and at least once by non-attendance would be recognized as such. Moreover, that person could be traced down through the identification provided for non-attendance.

A third example is when a fingerprint is applied to a part of a ballot that does not contain the vote codes, such as a supplement, but is intended to be retained for potential verification, as described elsewhere here. In this case, the ballot form itself is authenticated; as a result, it protects voters and the integrity of the election by providing deterrence against the form being changed before verification. Furthermore, the fingerprint can be used for the same purpose as in the first example, where multiple votes by the same voter are recognized to have occurred. Moreover, if a serial number or other unique identification of the form is provided, then presumably it can, in the case of multiple votes cast with the same fingerprint, be used to track for suitable remedy the electronic ballot and/or the voter.

### DETAILED DESCRIPTION OF PREFERRED EMBODIMENTS

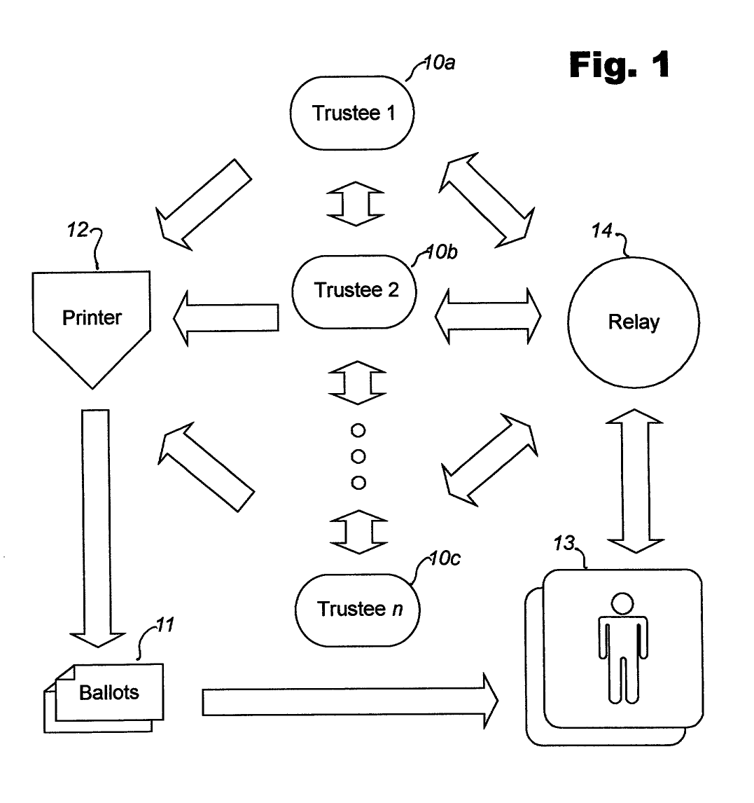

Turning now to FIG. 1, a combined block functional, and flow diagram is presented for an exemplary embodiment in accordance with the teachings of the present invention. A set of n trustees 10a through 10n is shown using an ellipsis to indicate that the total number may vary from 1 to as large as desired. But individual trustees will be referred to as trustee 10 and collectively they will be called trustees 10. Messages are shown going between the trustees 10 in both a forward and reverse direction to indicate that they are able to communicate among themselves, in some examples using intermediaries and/or arbitrary interconnection, not shown for clarity. Also shown is bidirectional communication between the trustees 10 and an optional relay 14. The relay 14 also communicates bi-directionally with users, often referred to for convenience as voters 13. (In some embodiments information travels only in one direction between trustees 10 and voters 13). Again, a variety of ways for messages to be routed between these parties can readily be conceived, while for clarity a particular example is used in the figure. Furthermore, unidirectional communication to the printer 12 from the trustees 10 is portrayed as pair wise and direct, but again can be accomplished in any suitable way.

Printer 12 takes input from the trustees 10 and produces physical ballots 11. These ballots contain confidential information that is protected in transit and obtained by the voter 13 who obtains a particular ballot 11, each voter is obtaining a single ballot in one example. The flow of ballots is one-way, but may include buffering as suggested by the plural ballots shown. More generally, multiplicity in a single system is anticipated for each type of entity. The trustees 10 are shown most explicitly, while that of the ballots 11 and voters 13 is shown in less detail. But plural printers and relays are also anticipated in some embodiments. Moreover, interaction of different combinations of the same type of party among themselves and with other parties is anticipated as well.

Turning to FIG. 2, an example paper ballot illustrating some of the inventive concepts is shown in plan view. The ballot 21 has serial number 70845211. (As will be appreciated, in descriptions of illustrations showing example indicia, for clarity the indicia will itself sometimes be used to reference the drawing, instead of introducing a separate reference number.) There are four-tuples, with the fixed order running column major. The shift amount is one. The candidates are indicated for clarity by symbols, “A”, “B”, “C”, and “D”, but the full names and/or other information, such as that identifying the contest, could as well appear there, or such symbols might be links-to more complete information, or, in other examples, position is used to indicate the correspondence. The challenge for candidate D is 4864 and the response is 7315. The dotted line 22 indicates that the serial number part is folded over so as to be right-side up. It may also be detachable through the perforation, to serve as a receipt. The cover over the triples 23, shown only in outline for clarity, can as an example be an opaque and tamper-indicating cover, such as a hologram pressed into a aluminum layer bonded to the codes or, as another example, it might be a layer of known scratch-away coating, performing a similar function.

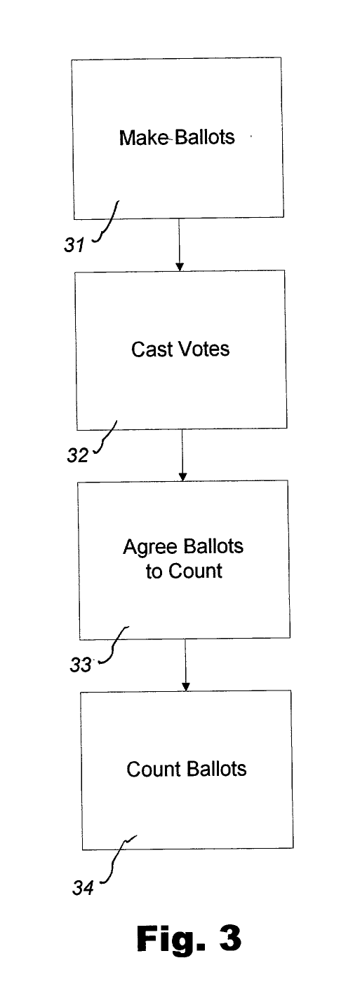

Turning now to FIG. 3, a combination block, functional and flow diagram of the overall process of an example embodiment in accordance with the teachings of the present invention is presented. Shown are the four phases, as already described, of the voting process in serial order: printing of ballots 31, casting of votes 32, agreeing on serial numbers to be counted 33, and counting the agreed ballots 34. Each of the four blocks is expanded on, in the next four figures FIG. 47, which appear in the same order as shown in this figure.

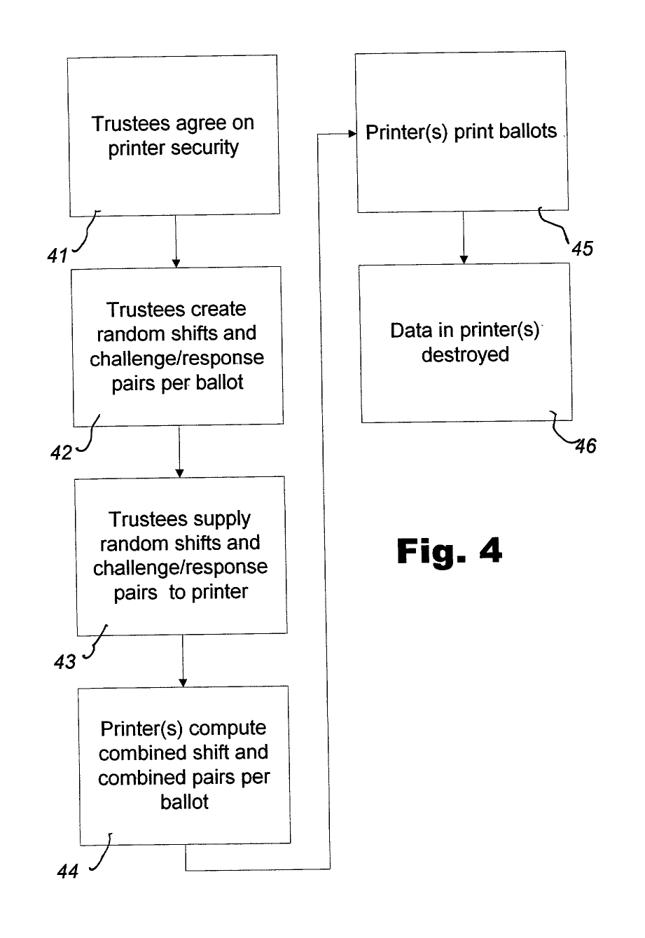

Turning now to FIG. 4, a combination block, functional and flow diagram of the making of ballots in an example embodiment is presented in accordance with the teachings of the present invention . The diagram covers six steps, the first of which, 41, is agreement on how printer security will be handled including, as mentioned, provisions such as tempest like prevention of the printer from leaking information during printing. Then each trustee creates, 42, the three values that they supply as their contribution for each triple on each ballot. After creation of a contribution for a triple, it is supplied 43 to the printer. The printer combines 44 the contributions, as already described, and print 45 the envelopes and their serial numbers. Finally, the printer may be zeroed or destroyed 46 to prevent it from retaining data it has learned. Not shown for clarity is any packaging and the actual transport and provision of ballots, along with any associated material comprising a ballot set, to the voter.

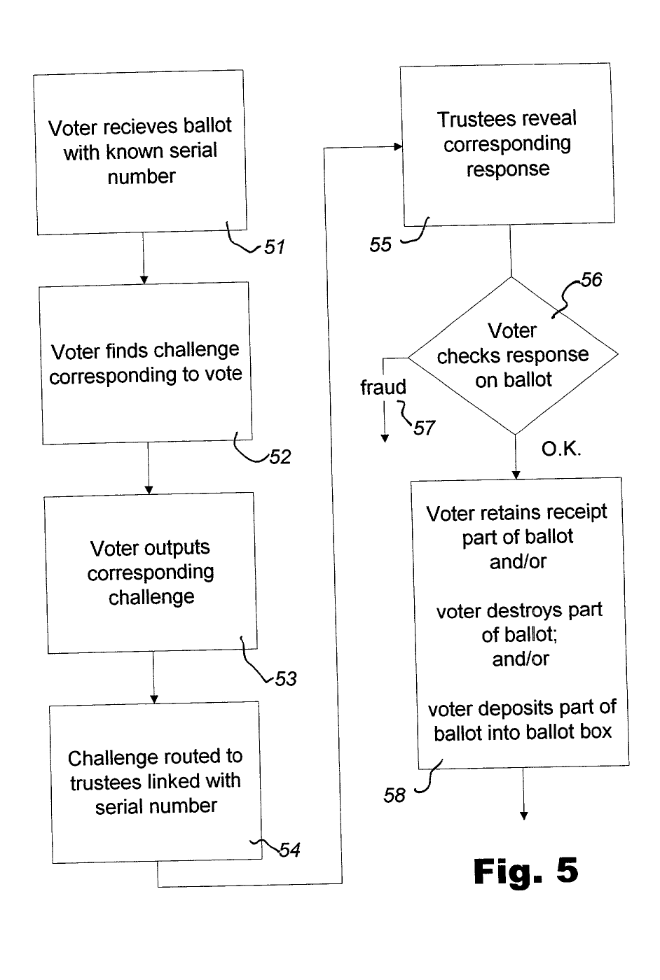

Turning now to FIG. 5, a combination block, functional and flow diagram in an example embodiment of the actual casting of ballots by voters in accordance with the teachings of the present invention, comprising seven steps. First a voter gets a ballot 51, i.e. and envelope in the preferred embodiment. The serial number is known to the relay and ultimately to the trustees. It might be associated with the voter 13, such as by video image or other data capture. The voter then opens the envelope and discovers codes 52, in the example at least the challenge, corresponding to the vote he or she wishes to cast. Then the voter makes this challenge value known 53 to the relay 14, who provides it to the trustees 10 along with, or in another way associated with, the corresponding serial number. The trustees 10 open 56 all the challenges for the serial number (and it should be noted that the serial number can be taken to correspond to a single known position of a vote code). When combined by the trustees, one of them (and there may only be one for that serial number) should equal that output by the user. The index of this one determines the position for this serial number and what response should be provided by the trustees. Each trustee then makes their contribution to the response value known to the relay, who combines them and provides 55 the result to the voter. Then the voter is supposed to verify 56 that this is what is printed on the envelope. If it is not, then the voter has detected fraud 57. When it is 58 what was printed, the voter disposes of all and/or various parts of the ballot form set in one or more ways, including as examples: retaining all or a part of the ballot as a receipt, shredding all or part of the ballot, mailing or depositing all or part of the ballot in, for example, one or more so called ballot boxes.

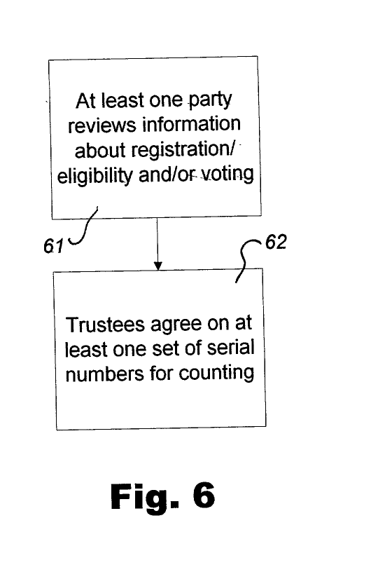

Turning now to FIG. 6, a combination block, functional and flow diagram of the decision as to what to count in an example embodiment in accordance with the teachings of the present invention is presented. As mentioned above, time can then be taken to decide 61 which ballots to count, each ballot being identified by its serial number. The trustees may decide which ballots were cast by those entitled to vote and which were cast with higher multiplicity than entitled. The result is at least one set of serial numbers of ballots voted that are agreed 62 by the trustees to be counted.

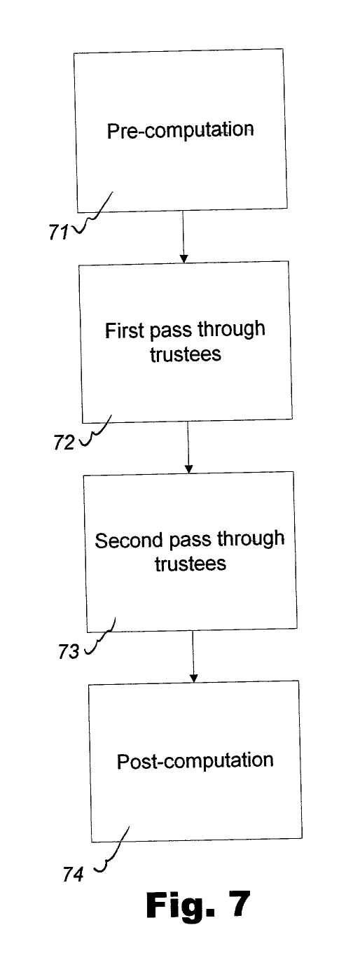

Turning now to FIG. 7, a combination block, functional and flow diagram of the overall process in accordance with the teachings of the present invention of, at last, actually counting ballots. This involves, as already described, four phases, each of which is shown. First is pre-computation 71, a first pass 72 through the trustees in sequence in the example embodiment, a second pass 73 in the same sequence through the trustees as the first, and then post-computation 74. Each phase takes the output of the previous phase as its input and produces output. The output of pass, post-computation 74 can be used to compute results of the election and is not shown for clarity.

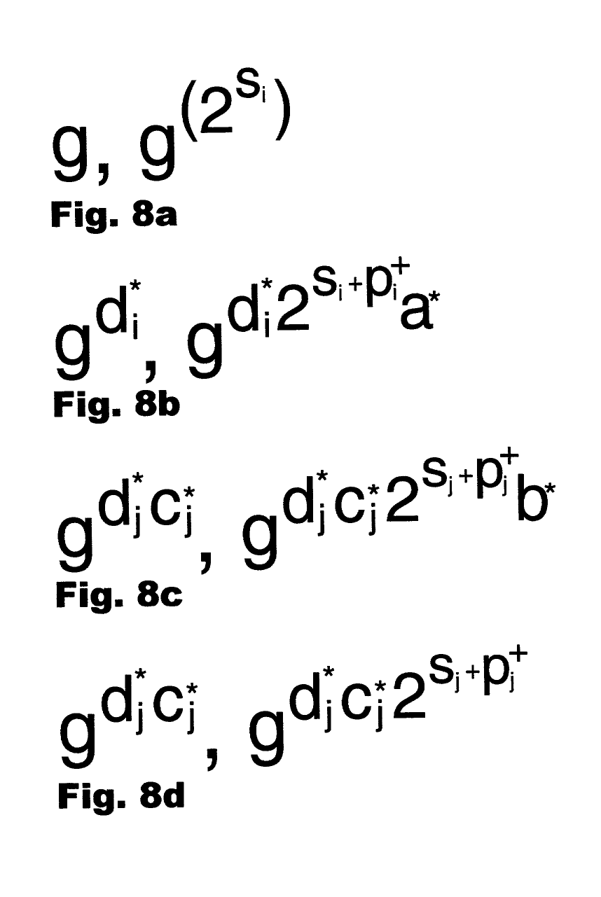

Turning now to FIG. 8, four formula schema are shown, one corresponding to the output of each of the four phases of one example embodiment in accordance with the teachings of the present invention. Each phase has a pair of residue classes in a discrete log system, shown without the sometimes used “(mod)” notation. The formula, FIG. 8a, is the output of the pre-computation. Its first element, is simply the generator, denoted g. The second element, separated by a comma as in all pairs in the figure, is the generator raised to a power. This power is itself a power of two, as already described. The actual power of two, denoted s,, is the position, counting in zero-based indexing, of the matching challenge as already described in the casting of votes. The index i represents the particular serial number; thus, there is one pair in the output batch per serial number, as already described.

Referring now to FIG. 8b, the pair output by the first pass and input to the second is show. It will be seen again that the index i is applied to all those values that differ per serial number. The first such value, the exponent d, is applied to both elements of the pair. It is chosen pseudorandomly, as already discussed. The star “*” superscript is a special notation used for clarity in this FIG. 8 to compactly indicate the product of all the values of the variable for the different trustees 10. Thus each trustee raises the first element to a random power, and the result can be written with the product of the exponents as the exponent. The second element includes the first as a factor, as mentioned. It also includes the power of two exponent from the pre-computation input. Pass one further includes a second power of two, corresponding to the shift chosen by the trustee. The superscript of plus “+” indicates a similar combination as star, but with addition instead of multiplication; as each power of two is multiplied in, by virtue of the exponentiation, the corresponding p's add. The value a is fixed for each trustee, but all the a's multiply.

Referring now to FIG. 8c, the output of the second pass and input to the third is shown. To suggest that the elements are no longer in serial number order, but in lexicographic order, the index j is used instead of i. The first element is similar in form to the first element input, but the value c has been applied to it, and this value is treated similarly to d before it. It will be appreciated that the values multiplied together according to the star notation are not for the same serial number, but rather each trustee's contribution is usually from a different serial number, as determined by the position of the pair in lexicographic order. A similar exponent of c has been applied to the second component as well. Furthermore the fixed exponent a, the same for all pairs processed by a given trustee, is removed, through in effect applying it inverse, by the trustee that put it there. What is applied instead is again fixed per trustee and denoted b.

Referring to FIG. 8d, the form of the pairs resulting from the post-computation is presented. The first element is unchanged from the output of the second pass. The second element differs only in that the value of b has been removed. The inverse of this exponent was calculated during the post-processing from the product of the values b that were revealed by each trustee.

Each of the four phases that have been described already with reference to FIG. 7, are now described beginning with the first of the four, the pre-computation.

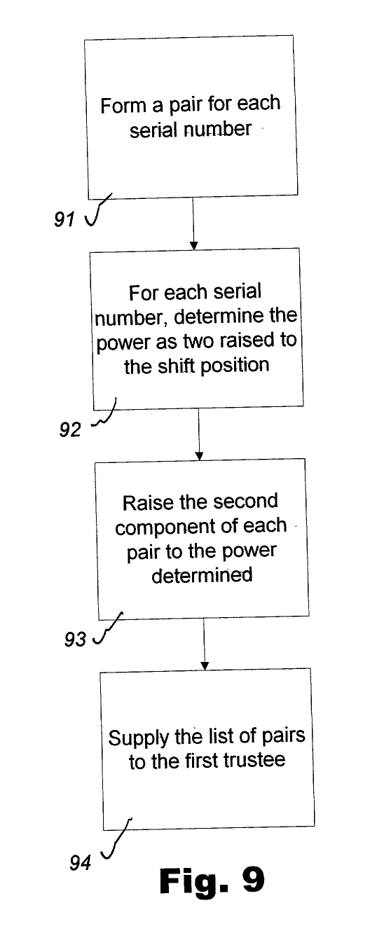

Turning now to FIG. 9, a combination block, functional, schematic and flow diagram of a pre-computation phase for an example embodiment in accordance with the teachings of the present invention. First shown is the forming 91 of a pair of elements for each serial number. Then the two power is formed 92 to encode the position revealed during the voting, as already described. Then the two-power exponent is applied 93. The output of this computation, which any trustee or other party could do so long as they know the position revealed during the voting, is then supplied 94 to the first trustee 10 in the sequence for the first pass.

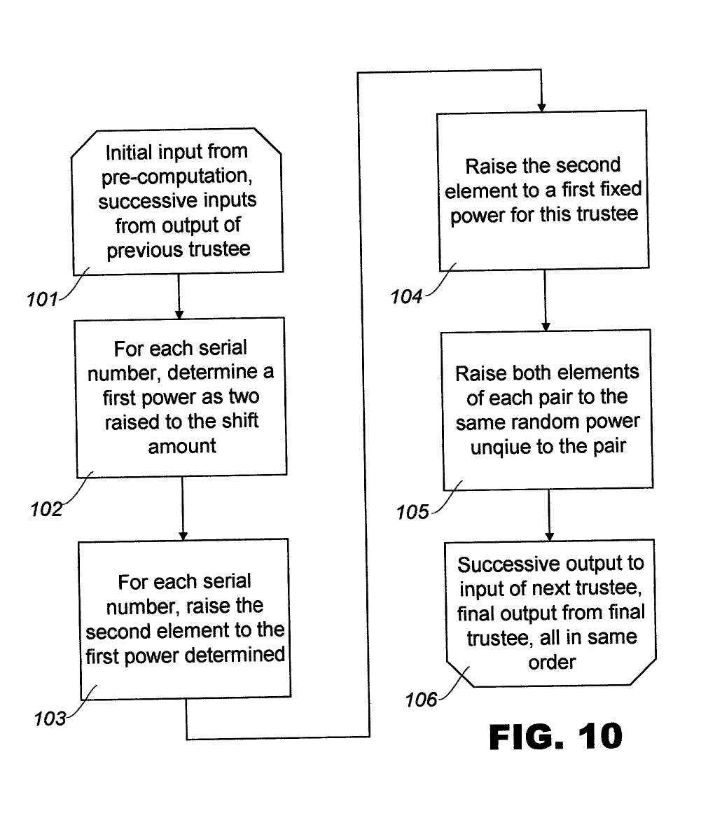

Turning now to FIG. 10, the first pass with its six steps is shown in a way similar to that used in FIG. 9. The first step 101 indicates that the input for this pass is from the output of the pre-computation of FIG. 9 and the pass works by feeding this ordered list of pairs through each trustee 10 in turn (as also suggested by the shape of the block being the beginning of an iteration). What each trustee does is the subject of the four blocks in the middle of the diagram, 102-105. The first of these, 102, is the computation of the two-power to encode the shift amount secret to this trustee. The second, 103, is to apply the corresponding exponent to the second element of each pair. The third, 104, is the application of the first fixed power. And the fourth, 105, is the applying the same pseudorandom exponent to the first and second element. The final block 106 indicates the chaining structure (also by its shape) and that the output of the final trustee serves as the output of the pass.

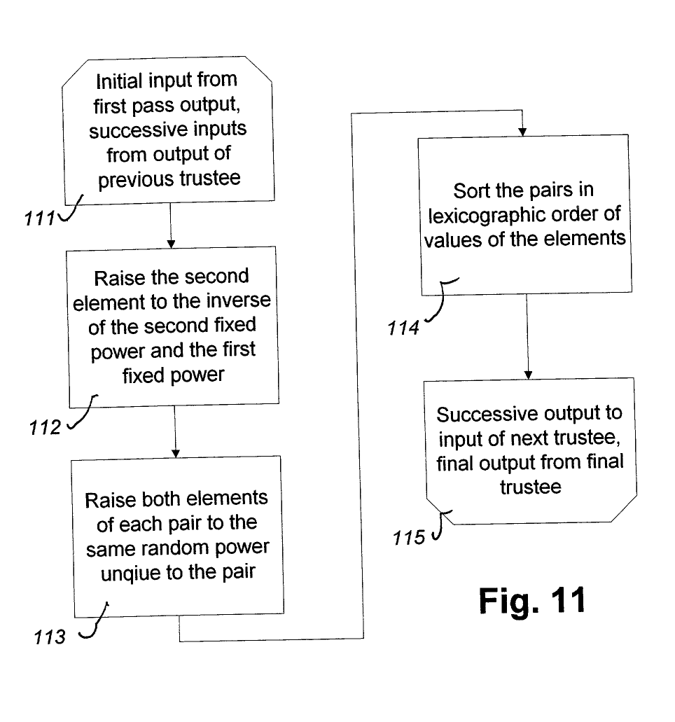

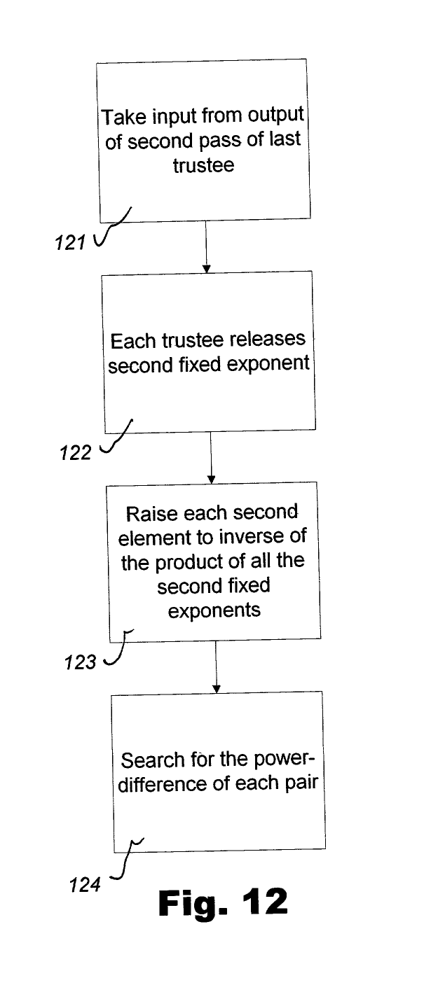

Turning to FIG. 11, the second pass is shown in a way similar to that of the first pass FIG. 10, also particularly in that the first and last blocks describe the source of input and output as well as iterated flow through the set of trustees. The first block, 111, indicates that the input is from the output of the first pass, being the output of block 106 of FIG. 10. The first internal block 112 to be executed by a trustee is to remove the first fixed exponent and apply the second fixed exponent of that trustee. The second internal box 113 is to apply the same pseudorandom exponent to both the first and second elements. The third and final internal box 114 calls for sorting the pairs in the output into ascending numeric order, when they are treated as numbers, although any fixed ordering will do. The final box of the FIG. 115 indicates that the output of the final trustee is the output of the pass.

Turning now to the final figure of the series of related and similar ones, FIG. 12, the post-computation phase is shown. The first box 121 shows that the input is taken from the output of the last trustee in the second pass, box 115. The next block 122 shows that each trustee releases it's second fixed exponent. The third box 123 shows that the product of these released exponents is formed, its inverse computed, and it is applied as an exponent to remove those remaining fixed exponents. The final box 124 shows that discovering the value of the public position plus the shift can be accomplished simply by trial and error.

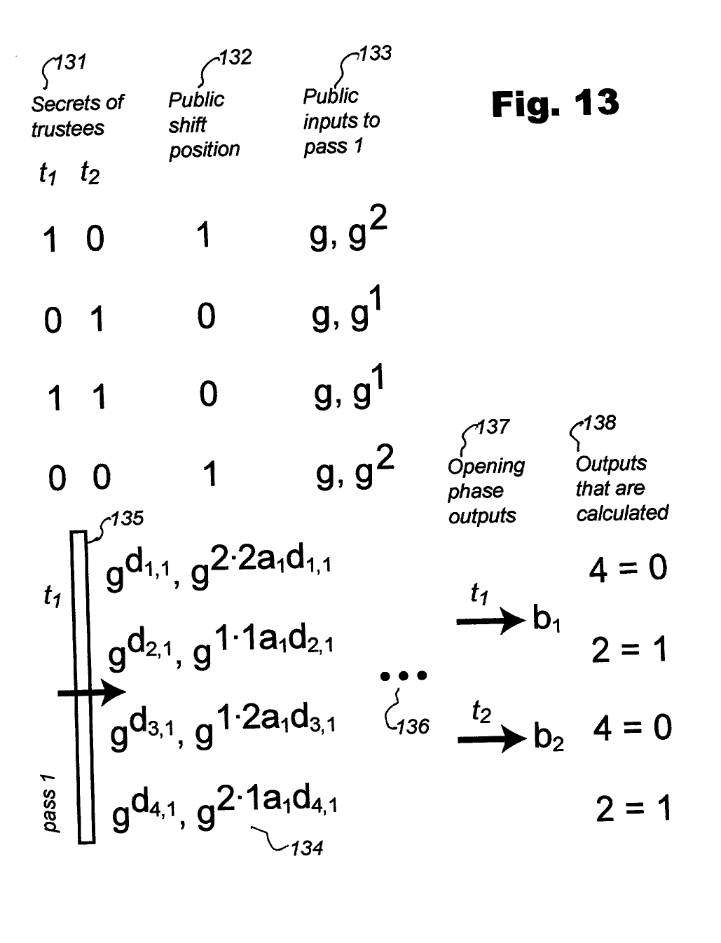

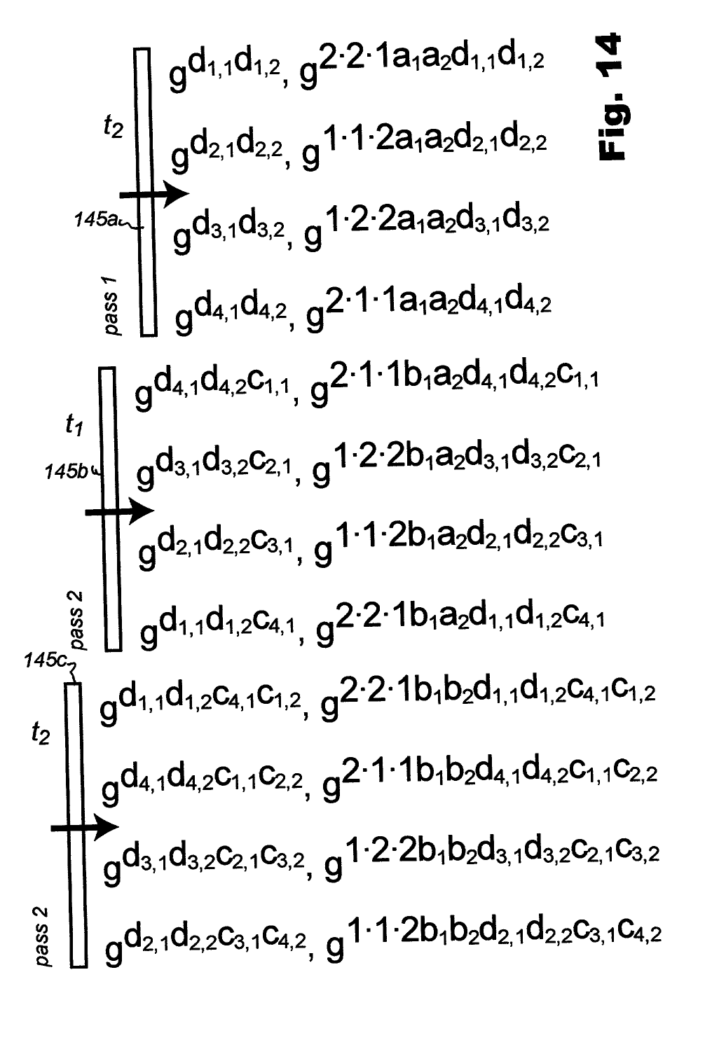

Turning now to FIG. 13, a first and final part of an example computation in accordance with the invention is provided to allow the concepts to be more readily appreciated (the intermediate states being detailed with reference to FIG. 14). The example has a single contest with two candidates, two trustees 10, and four ballots I1. Three tables, 131, 132, and 133 show the set-up before pass I begins. The rows of all the tables up through the end of pass I are in the same order, the row numbers are the public serial numbers but are not shown for clarity. In pass two, each trustee permutes the rows into an example different order and the final resulting output of the last trustee for pass two is in the order determined by the composition of these permutation.

The first table, 131, shows the secret shift amount each trustee has for each ballot. (As mentioned, each row corresponds to a ballot and each column to a trustee, in this case shown as t₁ and t₂) The shift amounts are shown as binary digits: one for shift and zero for no shift, in zero-based indexing as can be used for any number of candidates. Similarly, the public position (zero-based indexing), shown in the second table 132, are also represented as binary digits. In the third table, 133, the exponents on the second component of the public ballot pairs input to pass one are one and two, with one being the zero power of two and two being the one power of two.

The first pass has public input to trustee one 133 that produces output 134 for trustee two. The rectangle 135 is intended to symbolize the processing step/mechanism of a trustee 10 in a pass. Labeling, according to the convention used also in FIG. 14, explicitly identifies the trustee as t₁ and the pass as one. (The possibility to use shift-amount equivalent exponents, with its improved average efficiency and hiding is for clarity not included in this example.) As will be appreciated, ellipsis 136 stands in for the processing by the other trustees in the remainder of this pass and all the trustees in the second pass, as will be described with reference to FIG. 14. During the post computation phase, as described with reference to FIG. 12, trustee one reveals b₁ and trustee two reveals b₂, both as indicated by the table of arrows 137 labeled with the respective trustee names and yielding these values.

The final outputs can then be determined by searching for the missing exponents shown on the right hand side of the equal sign of the calculated output table 138, finding the two-power that each represents, and then computing, as shown on the left hand side, the modulo two result. In the example, there are two votes for each candidate.

Turning now to FIG. 14, middle stages of an example computation in accordance with the invention is provided. In particular, the parts left out from FIG. 13 as symbolized by the ellipsis and mentioned there are presented. This comprises e three transformations, the first pass by trustee two, 145a, the second pass by trustee one, 145b, and the second pass by the second trustee, 145c. As will be appreciated, the outputs of each stage are shown as for 134 of FIG. 13, and represent the application of the corresponding exponents to the two components of each digital ballot as detailed elsewhere. Also, as can be seen, the second pass permutes the ballots by changing their rows. The first permutation leaves them in reverse order; the second is a circular shift by two positions. The terms are collected together by type, but retain within the type the order in which they included. The first subscripts on some of the c and d terms begin to show the row permutations in the second pass and their second subscripts reflect the order in which the trustees are visited.

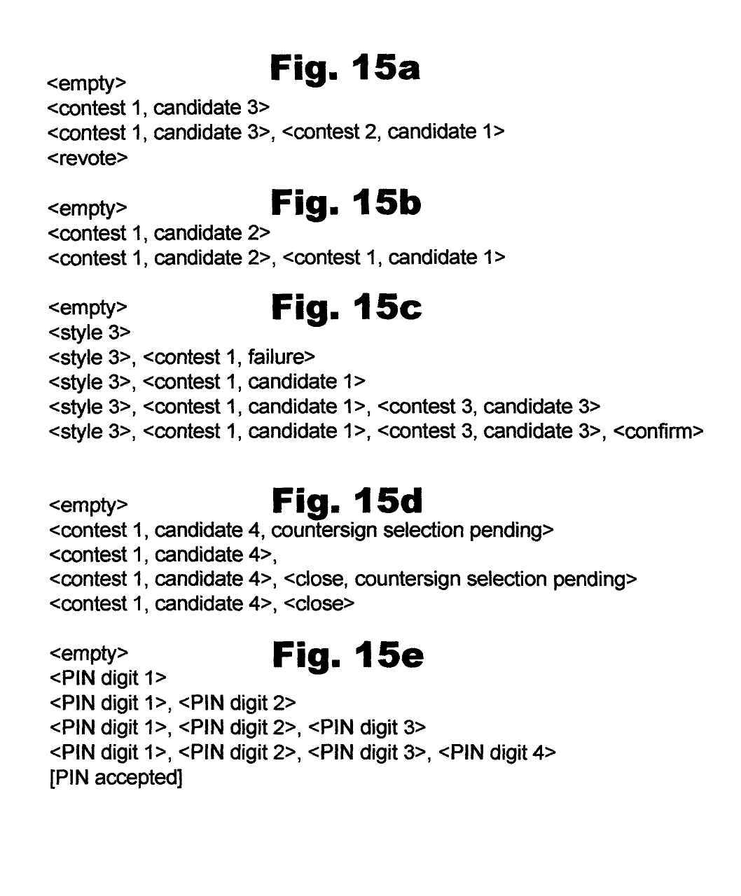

Turning now to FIG. 15, five example ballot state scenarios in accordance with the teachings of the present invention will be presented, in FIG. 15a through I Se. Each scenario shows a successive state on a successive line for a particular example ballot instance. States are denoted as comma-delimited ordered lists of items, each item being shown enclosed in angle brackets “<” and “>”. Other data, not shown, may be retained by one or more servers, keyed to the ballot serial number or other identification of the ballot state instance. The out-of-band data exchanged between voter/reader and the various servers can include the full state and/or requested or actual changes. The in-band data would be the actual codes, vote and/or countersign.

The first scenario, FIG. 15a, shows a simple example in which a ballot is used to vote for one candidate in each of two contests and then is cancelled by the voter so that a new ballot can be used by that voter. More particularly, and in the scenarios, the initial state corresponding-to the ballot is denoted <empty>. Once the first vote code is submitted (and the out-of-band information indicates that it pertains to this election and the first candidate as will not be described in further detail for clarity) checked and countersigned, the state is updated to show that a single candidate, with position three has been voted for contest number one. The <empty> entry has been deleted, for carity, as with the illustration of many of the scenarios, although in some embodiments complete logging of state transitions may be preferred. At a later point, and presumably within any time limit if there is one established, a second contest is voted. The state is updated to include this, say, contest two with a vote for position one. In the end, the voter decides to cancel the ballot, that is indicate that any votes in it should not be counted. Optionally, the voter is provided a new ballot with which to vote.

The second scenario illustrated, FIG. 15b, shows two different candidates being voted for the same contest, first candidate two and then candidate one. No end votes are shown, either because they are not used under the rules of the election and/or because this scenario can be regarded as a fragment that can be included in others.

The third scenario shown, FIG. 15c, includes multiple ballot styles and a failed vote. The first transaction, that would be by a control vote, indicates that ballot style three is being used, presumably with a corresponding supplemental ballot, as already described. Then the first contest vote fails. This means that the vote code submitted, together with out-of-band information determining this contest, does not verify. The rules may provide temporal and/or count limits on such failures, after which the ballot may be voided or other measures taken. In this case the limits have not been reached, and the voter succeeds in voting candidate position one for this contest. Then the voter votes candidate position three for contest three. At the end the voter issues a control vote that confirms the entire ballot, which is defined by the rules and may include criteria, if any, for its revocation. The fourth scenario, FIG. 15d, includes countersign selection and a single vote that is closed. First only the vote for candidate four in contest one is received and the state indicates that a countersign selection is now pending. The next transaction shows that the correct vote code was submitted for the previously issued countersign. At this point the voter has cast an end control vote that will close the ballot, but a countersign selection has not yet been made. Finally, the voter supplies the correct code according to the countersign and, in the example it corresponds to a close of the ballot. A probabilistic ballot may have been used, in which case the voter was lucky that the first attempt was a “done”.

The fifth and final scenario, FIG. 15e, is for a PIN code ballot or ballot fragment. It shows that each digit of the PIN codes is received in order. The digit numbers shown indicate the ordinal position of the digit not the value of the digit. The party or parties having access to the codes may have databases for recording various states related to the PIN codes, but these are not shown for clarity. These same parties provide an authenticated message that allows the database entry shown to indicate that the PIN code was accepted. This last state reflects authenticated/verified data from a party or parties and not the voter and ballot, and is accordingly denoted enclosed with square brackets “[” and “]”.

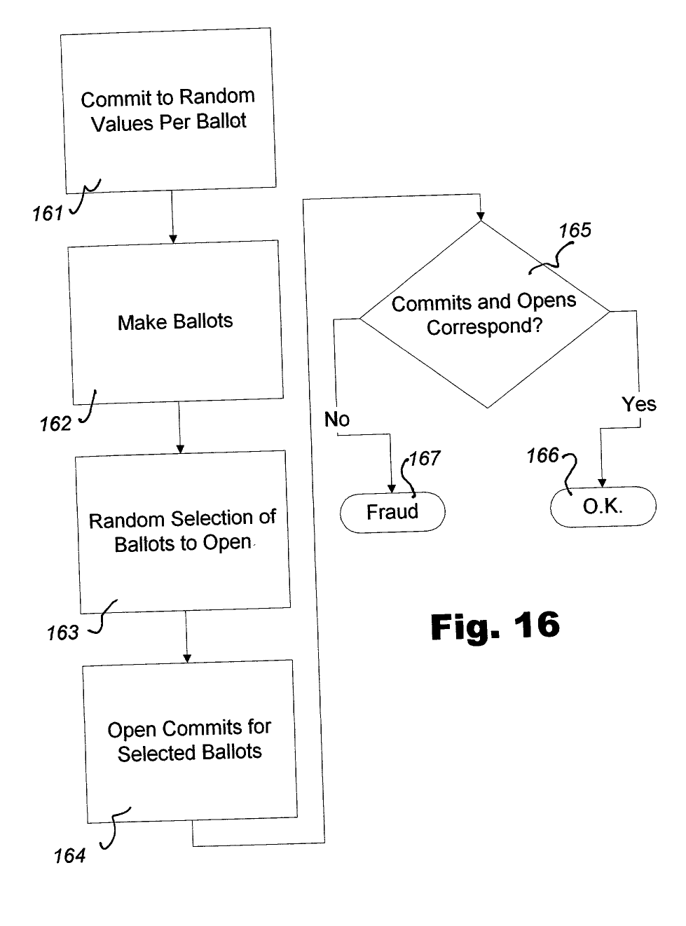

Turning now to FIG. 16, a combination block, functional, and flow diagram for an example audit concept in accordance with the invention is provided. Initially, each trustee chooses and publicly commits 161, such as by posting the image of the value under a so called “one-way” function or using some other cryptographic commitment scheme, either unconditional privacy or bijective, to a random value for each ballot serial number. After the corresponding commit is posted, the ballot can be printed 162. Printers can optionally be provided with some convincing cryptographic or other protocol proof, such as a zero-knowledge or minimum disclosure proof, that the values they are being asked to use to determine what to print do correspond to those that are published. This is intended to prevent the printers from having access to data that could be used to prove based on trustee published values how a ballot was cast even after it had been shredded. At the same time it protects the printers from being falsely accused later of having printed with the wrong shifts. All the values that a printer needs for a single ballot can be derived from a single Tandom seed, as is well known, and this is what could be committed to.

At this point the auditor(s) create 163 preferably mutually random values that select a subset of ballots for opening. As another example of many ways that the selection could be made, the ballots could be pulled from a hopper. Once the selection and its serial numbers are agreed, they can be physically opened 164, and for instance scanned. The digital commitments corresponding to the selected serial numbers are also opened. Finally, anyone can check 165 that the printer did the right thing, by following the procedure the printers should have followed based on the opened values. If all the ballots are correct, everything is O.K, 166. But if any ballot has the wrong shift amount, fraud or severe error is indicated 167.

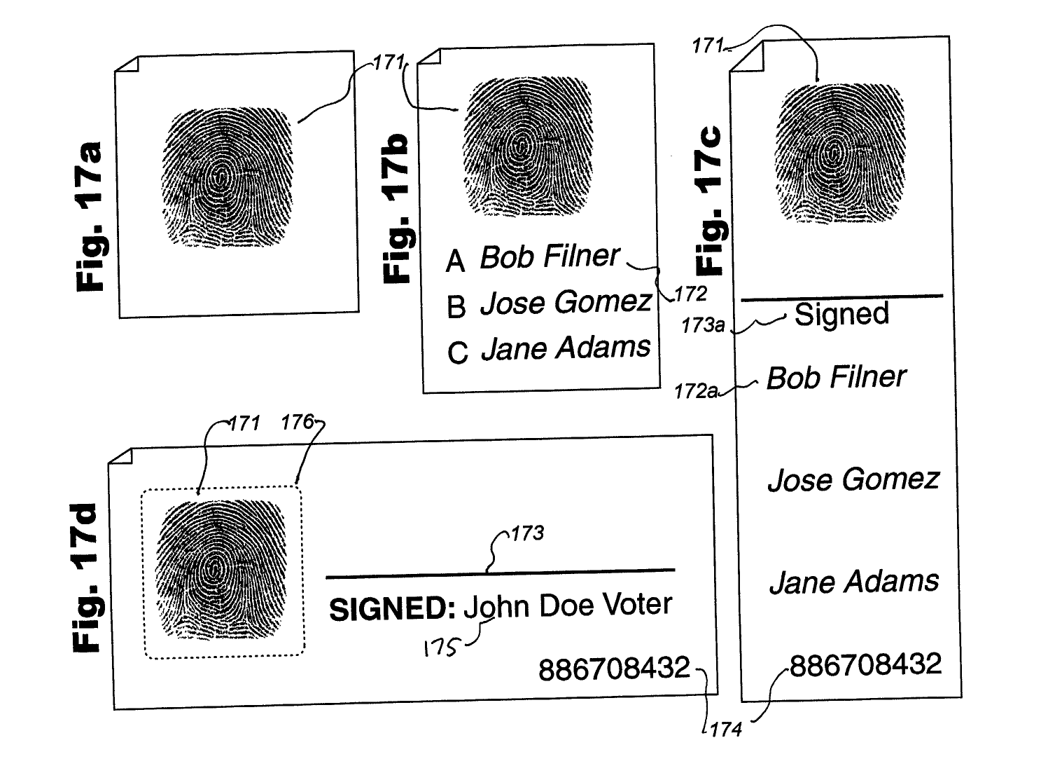

Turning now to FIG. 17, four example forms in accordance with the teachings of the present invention are shown, in FIGS. 17a through 17d. All four contain fingerprints and can be used to detect multiple votes by the same voter, as are here called “multi-votes”. The upper left form 17a is an example of an anonymous fingerprint form that could be placed in a hopper at a polling place, or otherwise supplied with a ballot, so that multi-votes can be detected and linked at least to the print. In particular, the voter fingerprint 171 is shown visible on the medium 172, such as paper. (Various ways to obtain prints are known, such as ink pads that leave no visible ink, peel-away coverings for microencapsulation-based systems, and so forth. Automatic readers, such as optical, capacitive, and so forth, can also be used to produce prints.)

The upper middle form, FIG. 17b, is a ballot supplement without serial number that can be collected at a polling place, by mail, or whatever means, and saved for verification of the ballot style 172a, which is authenticated as used by the fingerprint, and/or for multi-vote detection and/or linking to fingerprints.

The right form, FIG. 17c, is similar to that of FIG. 17b, except that it is designed for a card to be registered instead of linked by symbols and it bears an identification number 174. This number can be the serial number of the whole ballot, which would then allow the ballot to be voided in case multi-vote is detected for the fingerprint 171. The number can be proffered through a choice of codes by the voter/intermediary so that the trustees can determine the actual ballot for the vote. One advantage of this is that if verification determines that the style is improper, some correction can possibly be made. Another advantage is that if later the fingerprint turns out not to be from a valid registered voter, or the signature 173a does not match, then the ballot can be kept out of a counting.

The lower form, FIG. 17d, is without ballot information but does include a fingerprint 171, place for a signature 173, and a serial number 173. The voter name 175 is shown printed on the form, although it can optionally be an un-personalized blank form. The boundary 176 around the fingerprint 171 is intended to indicate that an attachable, laminated, or otherwise different region may be used for the fingerprint, as are known. When such a form is provided, if the fingerprint turns out to be multi-voted and/or does not match that stored in a database of registered or previously-used prints and/or the signature does not match that on file, then optionally the voter can be found/contacted and/or, provided the ballot serial number is the same or otherwise linked, the ballot can be invalidated.

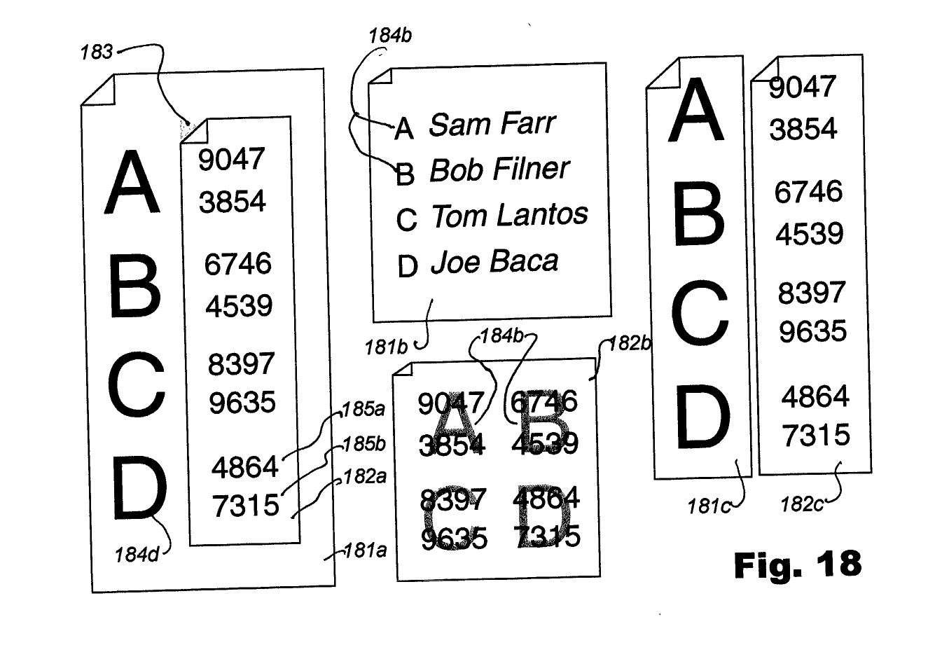

Turning now to FIG. 18, three example ballot sets in accordance with the present invention are shown, one on the left FIG. 18a, one in the middle FIG. 18b and one on the right FIG. 18c. The ballot set on the left FIG. 18a is another example of a supplemented ballot arrangement. The outer rectangle 181a is the supplemental ballot part and the inner rectangle 182a is the ballot itself. The ballot has been positioned on the supplemental ballot by means not shown for clarity, that might include and adhesive; registration or positioning, however, can be facilitated by marks on the form, an example without limitation is provided by way of a solid rectangle shading 183 that is to be covered by the attached card. The candidate names are represented by the familiar letter symbols, such as 184d, although any candidate name could be used. Each candidate symbol is shown positioned adjacent to the corresponding vote code and countersign pair 185a and 185b. As will be appreciated, multiple contests, front and end control votes, and so forth may in general be present on a single ballot.

Referring now to FIG. 18b, the middle ballot set, the supplemental ballot is shown above 181b and the ballot card itself 182b below. The two need not be attached, as in FIG. 18a, in order to cooperate. Letter codes are used in this example to indicate the correspondence between the code/countersign pairs and the candidate names. Thus, the vote code 6746, for instance, would correspond to the letter code “B” which is tied to the candidate Bob Filner.

Referring now to FIG. 18c, the ballot set on the right, shown is an example arrangement for juxtaposing the ballot 181c and card 182c in which they are laid side-by-side. Registration/alignment marks are not shown for clarity, although many variations are possible including instructions, illustrations, icons, and arrows or the like. A further variation here, not shown for clarity, would be where the ballot has a cutout window that allows the card to be seen through it.

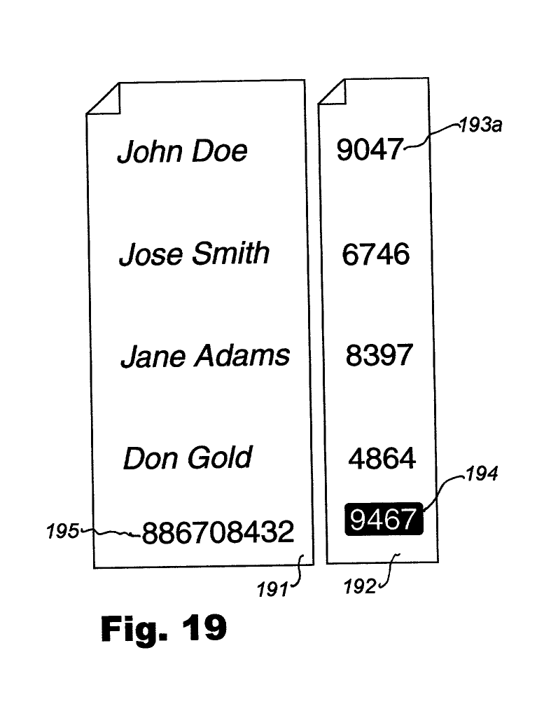

Turning now to FIG. 19, detailed is an example ballot form that illustrates variations in general form and also shows a serial number all in accordance with the invention. Shown is an example of a supplemented ballot in which two halves, 191 and 192 are aligned by being placed side-by-side as also described and shown elsewhere. Illustrated in this embodiment, but applicable in many, is a single countersign 194 for a multiple candidate contest. For example, with plurality voting and a single candidate, some economy results from having a single response code, although voters who overvote could be cheated by intermediaries in the absence of other controls.

The supplement 191, which in this case is intended to be retained for later verification as to its correctness and appropriateness for the particular voter, as mentioned, bears a serial number 195. This number can be the same as that printed in hidden form on another part of the ballot. It can also be the same serial number, or at least contain a common segment with or bear a predetermined relationship with the number printed on the outside of the envelope in some embodiments, that is tied to the voter registration roll entry.

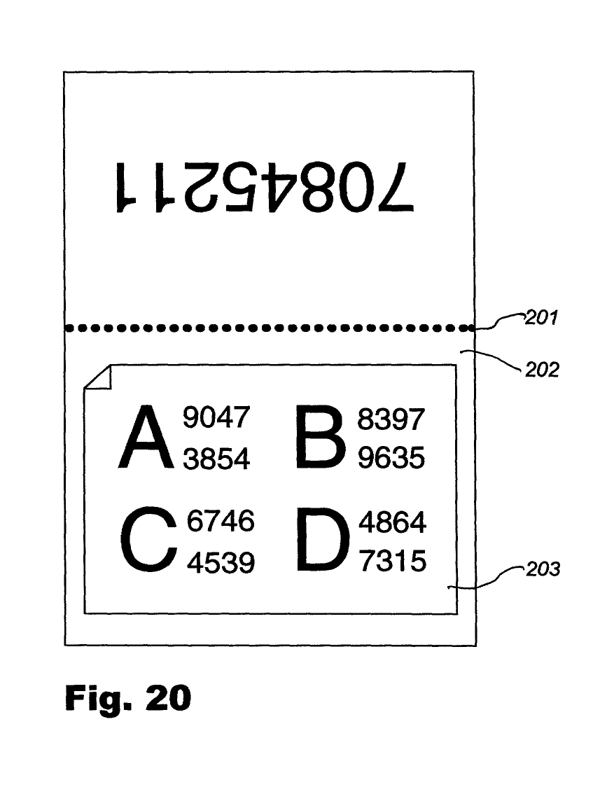

Referring now to FIG. 20, an alternate non-permuted embodiment to that of FIG. 2 is now presented, in accordance with the teachings of the invention. The ballot media 201, the optional perforation for folding 202, and the optional hiding cover, in particular, can be the same. It will be appreciated that the difference between the two figures is that the candidate symbols in the non-permuted version, FIG. 20, appear to be in a lexicographic or familiar order, whereas those in the other, FIG. 2, do not. The groupings of symbols, codes and countersigns is believed the same in each, with the difference in the figures being the position those groups are in on ballots. Once the ballots are formed and apart from the perceived difference for the voter, the two systems are believed to operate in the same way. Other examples presented here may vary in which approach they take for clarity. While permuted is believed to have security advantages, including that where a voter's eyes go need not reveal the voter's choice, non-permuted may be considered more convenient by voters.

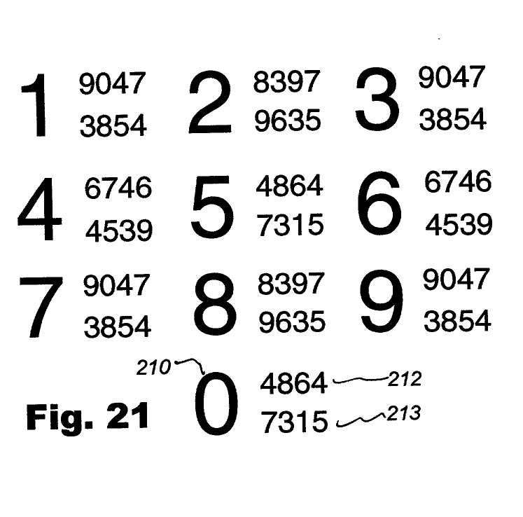

Turning now to FIG. 21, an example PIN code ballot part in accordance with the teachings of the invention is presented in detail. The ballot part layout is in the format of a US telephone keypad, with the Arabic digits 211 in row-major in three columns, zero in the center column. Adjacent to each digit of the pad 211 are two four digit numbers, 212 and 213, the upper one 212 is the control vote and the lower, 213, the countersign. Thus, to enter the PIN code “3597”, the voter first utters 9047. The system responds with the countersign 3854, which the voter checks. This communicates the first digit 211 “3” of the PIN code to whatever entity the trustees allow to participate in the protocol and recover it, that will be called the PIN server. Then the voter provides the code 4864 and the trustees respond to the voter with 7315, which the voter checks. Then the voter provides the code 0047 and the trustees respond to the voter with 3854, which the voter checks. Then the voter provides the code 9047 and the trustees respond to the voter with 3854, which the voter checks.

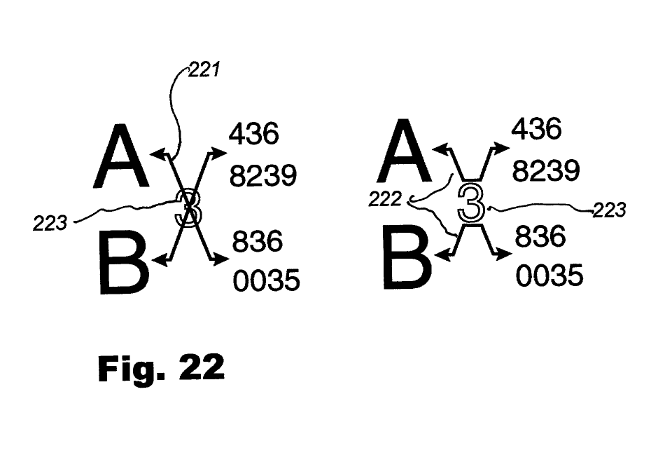

Turning now to FIG. 22, an example self-shredding ballot part in accordance with the teachings of the invention is presented in detail. Two alternate versions of the same contest are shown FIG. 22a and FIG. 22b. In FIG. 22a, the linking symbol 221 calls for the upper and lower symbols to be interchanged; whereas, in the FIG. 22b version, the linking symbol 222 calls for the upper and lower symbols in the same rows to correspond, that is not be interchanged. A scratch off layer on which the interchange symbol is printed and that hides the “3”, 223, is not shown for clarity.

In the FIG. 22a version, to vote for candidate “A” the voter 13 would first take note that the lower pair should be used, would then scratch away the latex that hides the “3” 223, and utter the “3” followed by the 836. The countersign 0035 should then be provided to the voter for confirmation. It should be noted that the intention is that removing the covering to reveal the “3” would result in the difference between the two interchange symbols to be destroyed; thus, the trustees 10 are provided at least statistical confidence that the ballot is rendered into a form that would not reveal the voter's choice to even someone that has heard the utterances and the countersigns. It should also be noted that these interchange symbols, 221 or 222, as has been discussed, could be printed by a different printer than that used for the codes and countersigns.

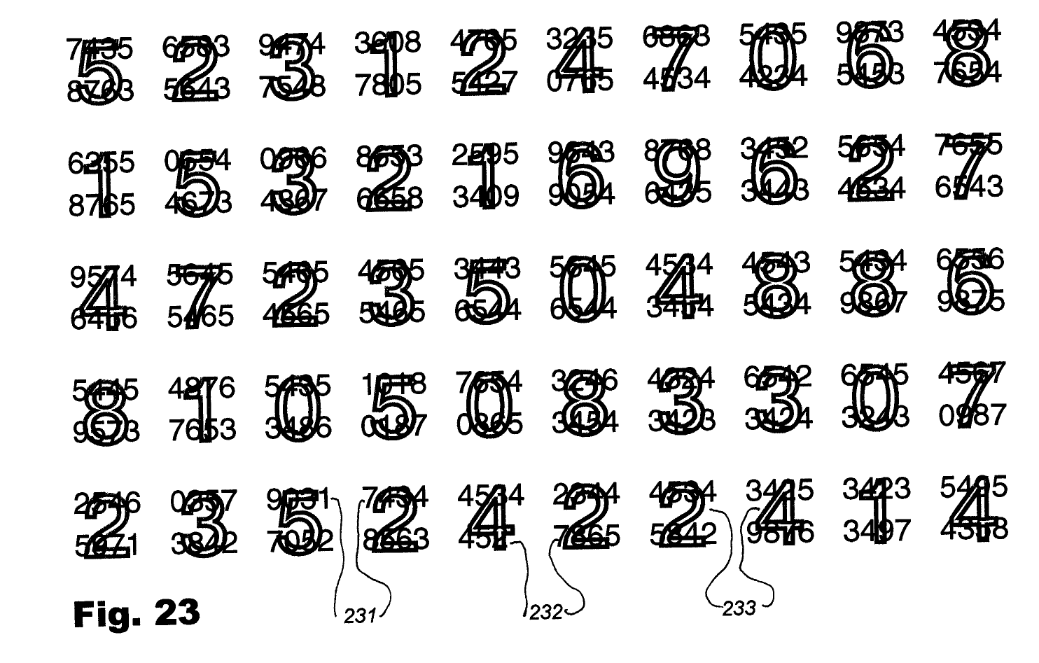

Turning now to FIG. 23, an example self-shredding PIN code ballot part in accordance with the teachings of the invention is presented in detail. A scratch off layer is not shown for clarity, but would hide the smaller numbers, 231 and 232, while providing background on which the larger numbers 233 are printed. Thus, in the non-scratched initial state, only the larger numbers 233 would be visible; scratching-off one of them would reveal the two, 231 and 232, beneath it and substantially destroy the larger one 233.

In use, a user/voter would first remove the latex under the first digit of a PIN code known to the user/voter, which of several instances of the digit that might appear is up to the user/voter. Then the user/voter would communicate the corresponding challenge 231 and, in some options, verify the corresponding response 232. This process would then be repeated for each of the digits of the PIN in sequence. Since the large digits 233 do not appear exactly the same number of time, an adversary obtaining a used card is believed to obtain little information about the PIN code that was actually used, even if the challenges 231 and responses 232 were overheard. Suitable ways to arrive at digits and placement 233 include, for example, random or pseudorandom distribution. For instance, one example is a substantially uniform placement and distribution, within the constraint that each digit enters with at least the maximum multiplicity that it can appear in codes.

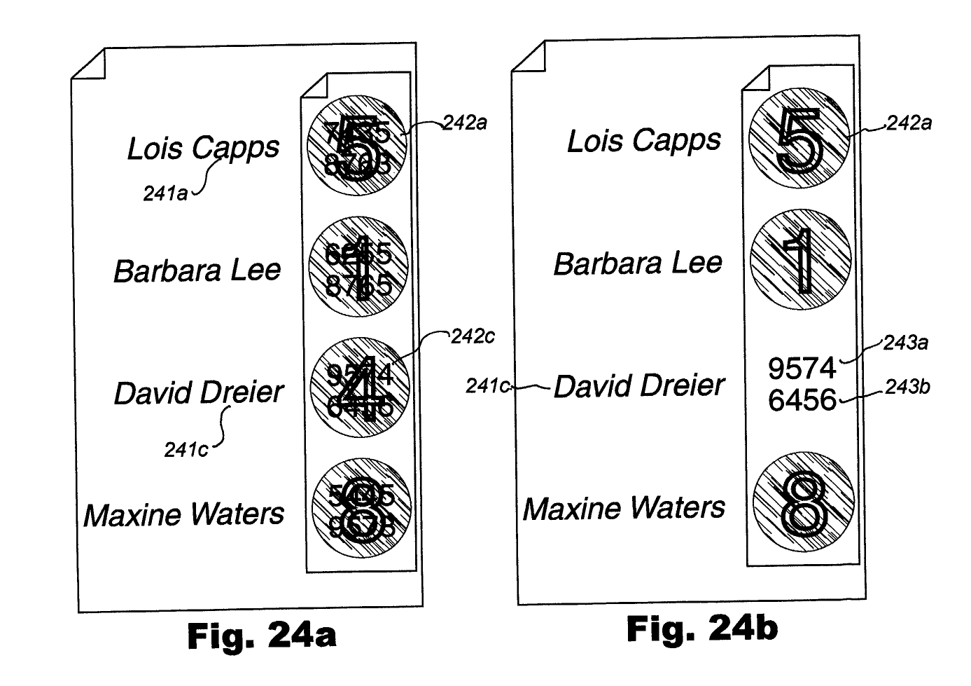

Turning now to FIG. 24, example retained-record ballot parts in accordance with the teachings of the invention are presented in detail, one before and after images, FIG. 24a and 24b, respectively. This ballot illustrates a supplemented ballot form with the candidate symbols in a relatively long form of names, 241a and 241c, e.g., of persons. FIG. 24a, the “before” image, shows the scratch-off material 242a and 24c, e.g., as a hatching pattern that, for clarity is transparent, but would in practice be opaque, as can be seen in the “after” image FIG. 24b. The example illustrated is where the third candidate from the top, “David Dreier”, has been selected by the voter 13, who has scratched away the corresponding hiding layer 242c, revealing the main codes, 243a and 243b. In voting this candidate, however, the voter would be required to state, at least with some probability, at least some something responsive to the indicia on the top layers corresponding to the other candidates. For example, the vote can be 5195748, which corresponds to the vote code 243a revealed pre-pended by the indicia above and post-pended by that below.

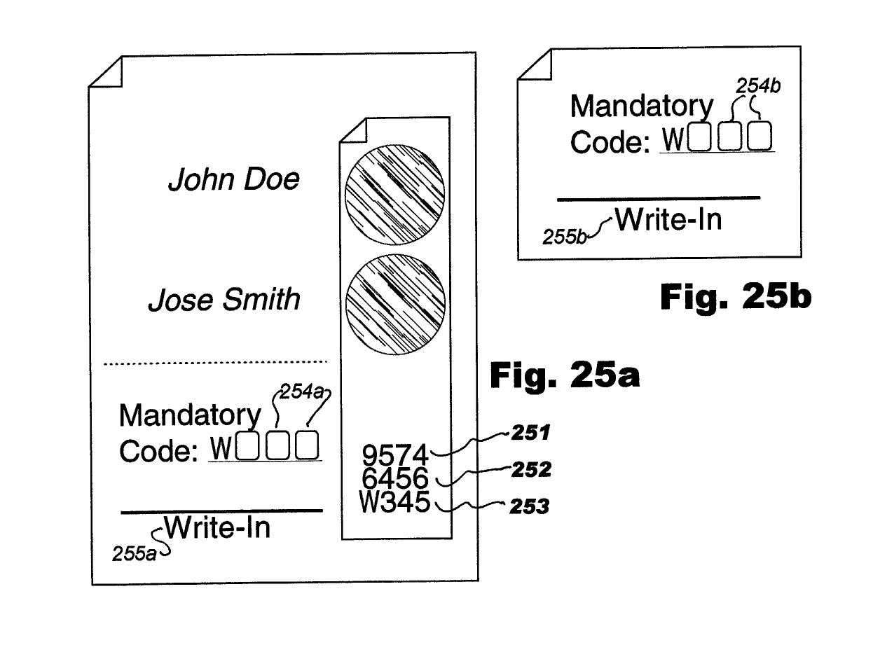

Turning now to FIG. 25, two example write-in ballot parts in accordance with the teachings of the invention are presented in detail, FIG. 25a and FIG. 25b. One, FIG. 25a, is a supplemented ballot card with two pre-printed candidates above a third slot for write-in. The other, FIG. 25b, is a write-in form without candidates. If write-in is selected, then the corresponding spot would be scratched off in FIG. 25a, not shown as it is already removed. What is revealed includes, as shown in the illustrated example, are challenge 251 and response 252 codes and a write-in code 253. The example write-in code 253 shown includes a predetermined part, the letter “W” shown in a special font, that is intended to indicate to the voter which code is to be filled in within the “mandatory code” space provisions 254a. Also, the number of digits has been made different for this code so that the other codes, 251 and 252, will not fit. Furthermore, the word mandatory is included and the code is above (and therefore before) the actual write-in space 255a, again to encourage voters 13 to fill it in. The space labeled “Write-In”, 255a or 255b, can include the customary provision for an office to be written in, however, it would not be needed if the write in codes 253 are unique per contest within a serial number. If the serial number is not contained on the card, in either FIG. 25a or 25b, then it can be included in the code, illustrating an instance of a principle that can be applied generally. With FIG. 25b, the write-in code would be provided in a similar manner from whatever ballot is being used and should be entered in spaces 254b and the candidate in 255b.

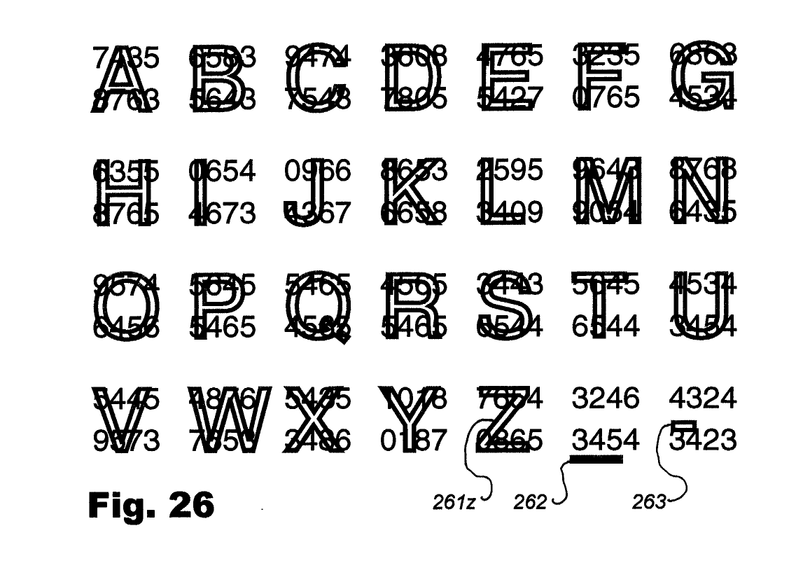

Turning now to FIG. 26, an example type-in ballot part in accordance with the teachings of the invention is presented in detail that allows a candidate name, especially one not already present on a ballot, to be entered. Symbols sufficient to indicate the candidate are included and each associated with a challenge and response code in the example, although many other arrangements anticipated here could be used as well. In the example shown, an alphabet, e.g. 261z, blank space 262, and hyphen 263 are shown as examples. The voter 13 would vote the codes, such as 7654 for 261z, corresponding to a spelling of the name of the write-in candidate, the “write-in candidate name”. For example, voters 10 might be instructed to use write-in candidate names comprising the last name or an abbreviation in case of a party or organization name.

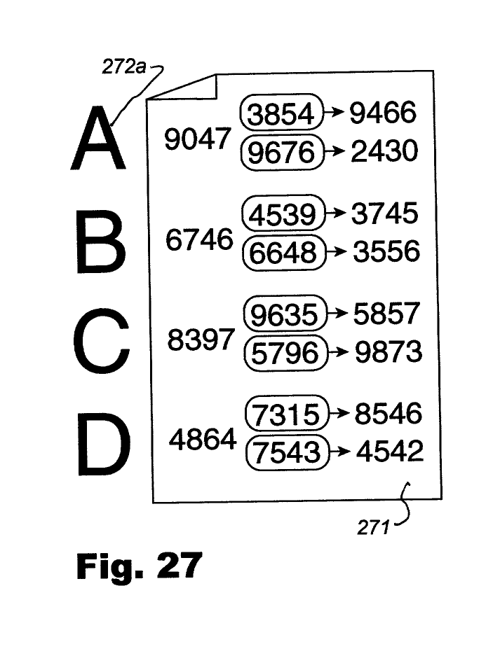

Turning now to FIG. 27, an example interactive ballot part in accordance with the teachings of the invention is presented in detail, an example countersign selected ballot part is detailed. The rectangle with folded corner 271 indicates a ballot card, whatever else could be placed on it. The four letters on the left, 272a e.g., are on a ballot supplement not shown further for clarity and are symbols representing actual candidates. To vote for candidate “C” for instance, voter 13 would utter vote code 8397. Then the trustees 10 would provide one of the two countersigns adjacent to it, 9635 or 5796, substantially unpredictably, such as a mutually random value as is well known in the cryptographic art. Suppose the lower one, 5796, is provided to voter 13. Then what voter 13 is supposed to do is locate the value 5796 among the two and then utter the value pointed to by the arrow around it, 9873. A countersign corresponding to this code can be provided in some embodiments, but as an instance of a general principle, when multiple votes of this type are arranged in a series, the state transitions and rules can enforce that the next countersign is given only when the previous two codes supplied are valid codes for the same previous candidate.

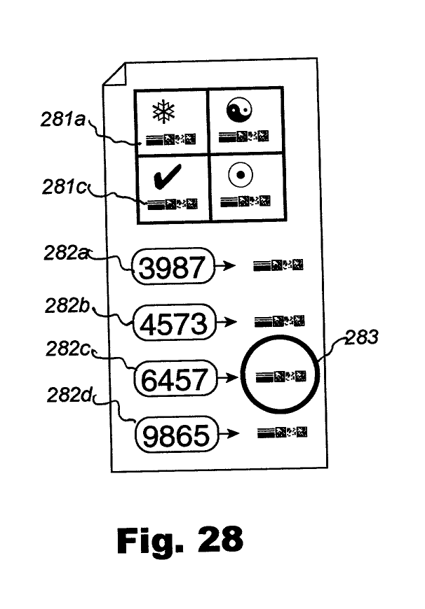

Turning now to FIG. 28, an example ballot part in accordance with the teachings of the invention is presented in detail, being an example countersign selected ballot part including a hybrid symbologies. The ballot contains barcodes, 281a e.g., which could be any machine readable indicia, that are shown for illustrative purposes as so called two-dimensional barcodes with finder pattern. (All the barcodes shown are actually identical, for convenience in illustration, although they would naturally be different in practice.)

Not shown for clarity, in one embodiment, the reader would be capable of one of a small number of types of auditory (and/or simple visual) feedback for each response; the type would visibly be indicated to the voter, such as by color, icon, or any suitable visible indicia, but would not be read but rather supplied to the reader by the servers as part of the response. For instance, a red dot might indicate one beep, no dot two, and a blue dot three.

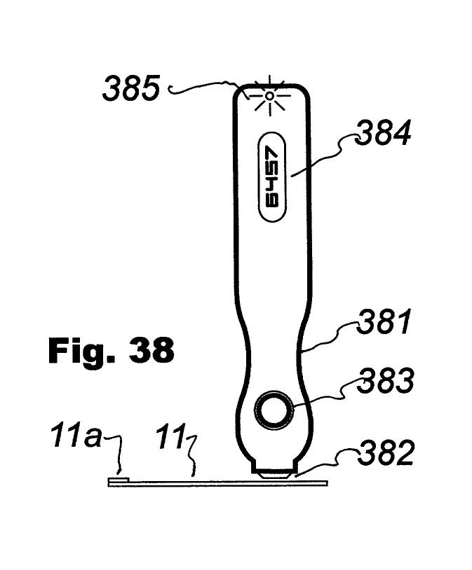

In an example operation, the voter chooses between four candidates in an example contest, each represented by a symbol, shown for illustrative purposes as a snowflake, yin-yang, checkmark, and bull's-eye. Suppose, for instance, that the voter wishes to vote for the candidate symbolized by the checkmark. Then the voter positions a barcode reader, such as that shown in FIG. 38, with its head 382 above the checkmark and activates it, such as by pressing a button 383. This activates the reader to read the barcode shown there, 281c. This provides the reader processor 391 and memory 393 with a corresponding vote code and an “internal” countersign. Then the reader can optionally lock up the button 395b and/or provide feedback 384 to the voter that the codes has been read, such as for instance a beep or change in a light emitting diode 385. At preferably substantially the same time, the reader transmits the vote code to the trustees 10. What they return preferably contains two countersigns. The first the reader checks against that read, and if there is a match, preferably unlocks the button 383 and provides additional feedback to the voter signifying acknowledgement of the read by the servers.

At this point in this example a countersign selected scheme is employed as just one example way for the user to confirm the vote. The servers have chosen, preferably by substantially mutual random techniques, one of the four countersigns, say, 6457. This is displayed 384 and/or audibly provided to the voter 13, who is to search for it among the corresponding list shown, 282a, 282b, 282c, and 282d. After locating the particular code, 282c in this case, the voter then positions the reader head 382 above the corresponding barcode, as shown by the circle footprint 283 at the end of the arrow (although it could be overprinted, say, in a different color), and the reader acknowledges and sends this code. As has been discussed, if there are a sequence of such votes, not shown here for clarity, then the voter-visible countersign for this last read can be provided in effect as part of the next read and/or for instance by a count type of end vote. It will also be appreciated that barcodes were used for some codes and Arabic numerals for those to be checked by the voter, but that human readable versions of the barcodes can allow the same ballot to be used alternatively without a reader in case circumstances so dictate, such as when readers fail.

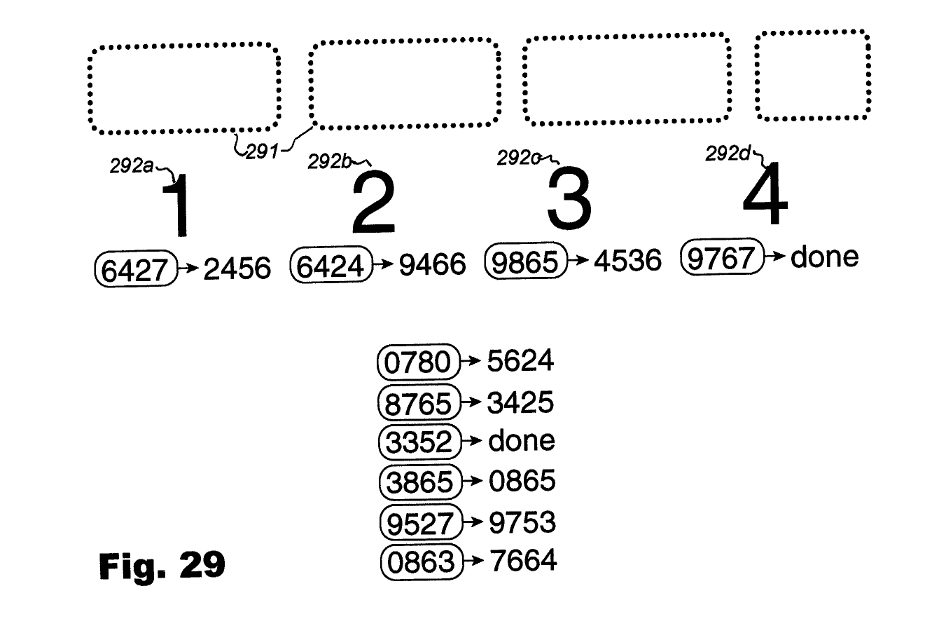

Turning now to FIG. 29, an example probabilistic-count ballot part in accordance with the teachings of the invention is presented in detail. The dashed boxes, 291, indicate four other contests on the ballot, each preferably with a single candidate, the details of which are omitted for clarity. After one or more of these are voted, the ballot is to be confirmed using the remaining indicia shown. The voter 13 is supposed to choose the numeral, 292a, 292b, 292c, or 292d, corresponding to the number of votes already cast. Thus, if the voter voted in three of the four contests above, the servers are aware of this and will accordingly start with the column labeled “3” 292c.

First the servers provide the countersign 9865. The voter should then check the column “3”, because the voter knows that three contests have been voted. When the voter finds the code 9865 there, the voter learns that the servers have received all three vote codes and provides the countersign pointed to, 4536. The servers choose at least unpredictably among the six rows in the example, say, 9527, which is provided to the voter. The voter then searches for this value and finds the corresponding countersign, 9753, and then provides it. In the next round, the code 3352 is provided the voter. Upon searching for it, the voter finds the word “done”. At this point the voter can be sure that all of their votes have been lodged. As will be appreciated, a similar approach can be applied without “done” appearing and using a fixed number of rounds.

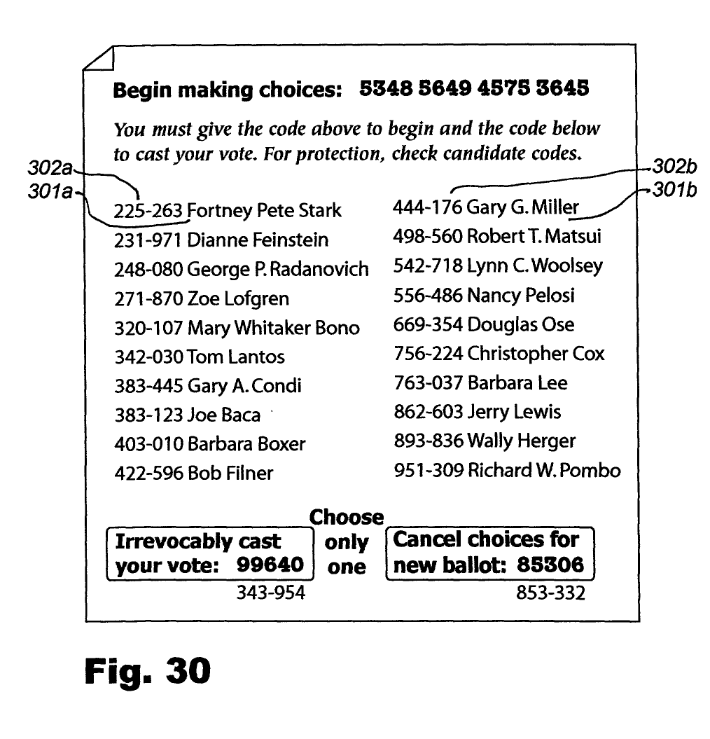

Turning now to FIG. 30, an example first passive ballot in accordance with the teachings of the invention is presented in detail, being an example ballot form that illustrates, among other things, a passive ballot technique. A list of candidates 301a, 301b, and so forth, including as an example in one list candidates from multiple contests, is printed. Each candidate 301x is paired with what, as an example, is a response code 302x, such as 301a and 302b. The entries shown are sorted, as just one example, in a lexicographic ordering related to the response codes for convenience of the voter 13. Other ordering examples include, but are not limited to, grouping by contest and/or ordering and/or arranging in a way that corresponds with or is otherwise suggestive of the layout of ballots that present the choices.

Other elements are also illustrated as examples that can be used together with or separately from the passive ballot. One is a “begin code” 5348-5649-4575-3645 that the voter is intended to enter into the automatic system to begin the voting process for at least part of the ballot. This code can be understood to be, in terminology explained elsewhere here, a challenge code that has no response and is a control vote that puts the ballot in a state that allows voting and any associated timing function to start. A second element is the “confirm” challenge 99640, that is shown in this example with a corresponding response 343-954. A third is the “cancel” challenge 85306, that is shown in this example with a corresponding response 853-332. Also shown are example explanations: “begin making choices”, “irrevocably cast your vote”, and “Cancel choices for new ballot”. Further, example instructions for the voter are provided: “You must give the code above to begin and the code below to cast your vote. For protection, check candidate codes.” and “Choose only one”.

It will, however, be pointed out here that the begin code is of a length that is intended to suggest that it include, and it optionally can include, the ballot serial number and some redundancy in a suitably scrambled form. The begin code can also, as a further example, include a “password” or personal authentication code part. Thus, as would be appreciated, in some examples there would be no serial number visible on the outside of the ballot, providing at least some real or at least perceived anonymity to the voter. Redundancy in the combination of serial number and begin code would preferably be controlled by the servers/trustees to prevent spoofing and exhaustive trials. The redundancy could allow simple typing mistakes to be forgiven. Apart from error correction, the number preferably is mapped by a cryptographic one-to-one mapping by the trustees or their agent for this purpose, so that whatever structure, such as the serial number and begin codes can be kept from being manipulated.

The operation of this ballot will be described in detail. Initially, the voter 13 enters the begin code 5348-5649-4575-3645, say on a touch-tone phone or a web browser, for instance. Then the voter chooses candidates and reviews choices by whatever user interface is provided. At various points during this process, as requested by the user and/or determined by the relay 14, choices are supplied by relay 14 to the servers 10. Thereupon, the relay obtains the corresponding response codes. (Digital signatures or the like could be used to authenticate and certify such responses of the servers, and also in general where applicable anywhere related to the inventive concepts disclosed.) The codes could be obtained in batches and/or, for example, one by one. The relay would display the codes to the voter and the voter would look them up on the sorted list and verify that the candidate name 301x next to the number 302x looked up is the candidate voted for.

At the end of the process of choosing and verifying, the voter has two choices. They can either cast or cancel the ballot. To cast, they give cod 99640 and wait for countersign 343-954 so that they know their vote was cast.(Interactive closing can offer advantages and could also be applied at this point, but it is not shown for clarity.) To cancel, they can do nothing and destroy the ballot or otherwise ensure that it at least times out before someone else could obtain it and cast the vote. But to obtain another ballot, they should provide the cancel code (or have waited beyond the timeout), 85306, and should then receive the confirmation 853-332. A new ballot can safely be issued a voter who has cancelled, either upon verification of the confirmation 853-332 as printed or by learning from the servers that the ballot has been cancelled.

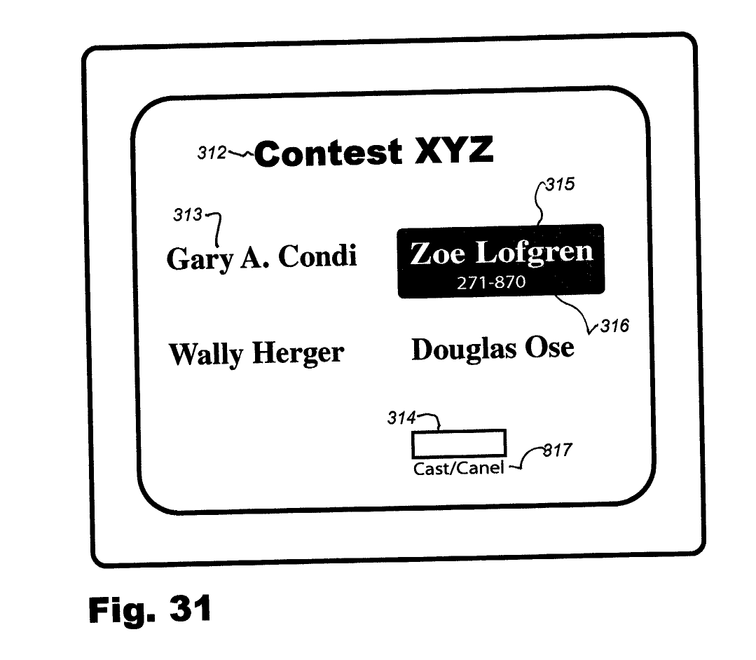

Turning now to FIG. 31, an example user interface screen device in accordance with the teachings of the present invention is shown. Screen 311, such as a touch panel or the like, is shown configured to display plural candidates and codes for at least a contest 312. In particular, the contest example is a winner-take-all between four candidates: Gary A. Condi 313, Zoe Lofgren, Wally Herger, and Douglas Ose. Also shown, combined for economy and convenience at least in exposition, but that can be independent, is a number entry box 314 that a voter can use to confirm or cancel that ballot (the open entry already being carried out and not shown for clarity).

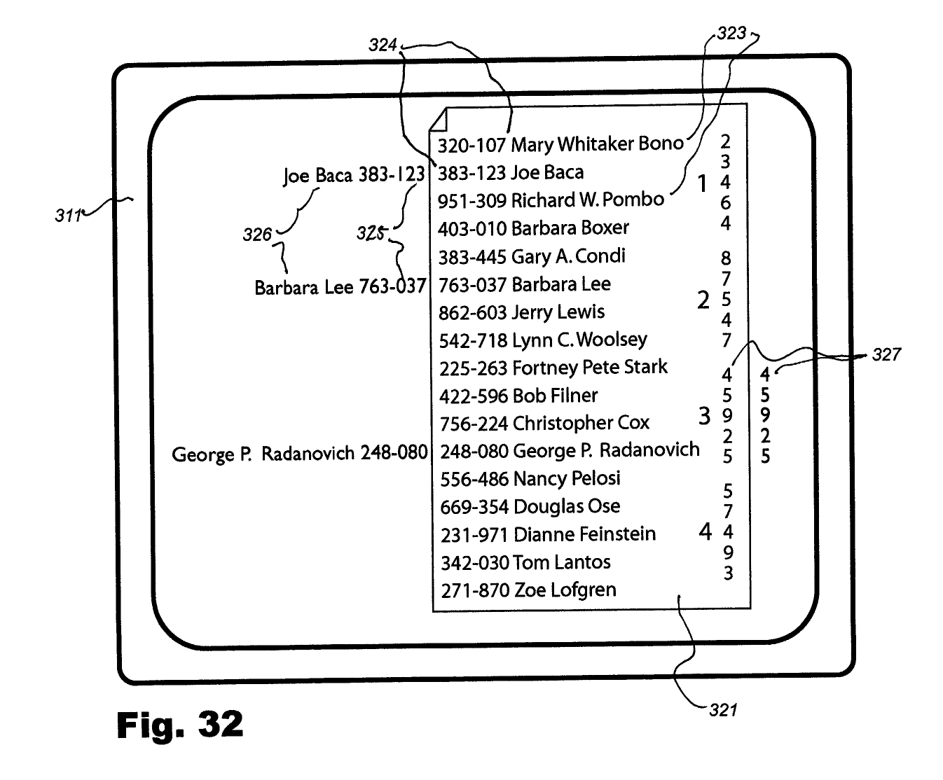

The voter has selected, for example by touching, the candidate Lofgren 315, causing this candidate to become clearly highlighted or distinguished as the selected candidate. Also, distinguishing the candidate, and providing the passive response, is the number 271-870, labeled 316. This number 316 is to have been obtained from the servers/trustees by the intermediary equipment processing the transaction. Thus, the voter is intended to optionally, but preferably, at least in some cases, to verify on the ballot card that the name and number are associated. This is done, in this example, most efficiently by the voter observing the number displayed 316 on the screen 311, searching for the number among the ordered list of numbers provided on the ballot, such as that in FIG. 32, and verifying both that the number is on the list and that the Zoe Lofgren is paired on the list with the number.

In another example, not shown in this figure but that can use the same passive ballot already shown, an interactive variant can be accomplished. The first three digits, for example, would be used as already described, but the remaining three digits would be provided by the voter to the device. This would have the effect of ensuring that the voter did verify the codes. More generally, this indicates that the challenge and response can be used in a different order: first the response is provided to the voter, who is then to provide the corresponding challenge. It is believed, however, that the challenge first ordering allows the voter to send the choice in a form that hides it from intermediaries.

The screen 311 also shows a place 314 for the confirm or cancel code to be entered. This could, in some examples, be separated for the two and/or include instructions 317, such as those shown on the ballot, and/or be on separately rendered screen images. The rectangle 314 indicates in customary fashion a space for entering of text, Arabic numerals or digits in the example of the ballot. The digits could be entered, for instance, by a separate keyboard or by selecting from one on-screen that is not shown for clarity. The corresponding countersign from the ballot should then be displayed as a response.

Turning now to FIG. 32, an example combination of a visual display unit 311 and a ballot card 321 in accordance with the present invention is described in detail. As can be seen, the ballot card 321 is positioned up against display 311 according to alignment cues/marks not shown for clarity. The candidates voted 323 are listed on the display 311, with the countersign numbers 324 for each. These countersign numbers 324 line up with the corresponding numbers 325 and names 326 on the card 321, which can be in a pre-determined and fixed ordering and position, or in one that depends on part of the response numbers not shown. In this example, the number of candidates chosen is three, and this number is confirmed by a corresponding response code 327 to the right of the digit “3” on the card, 45925, also shown in corresponding position on the screen.

The computer/logic, not shown for clarity, associated with the screen renders choices for the voter. After the voter makes selections, these are relayed to the servers/trustees, preferably in a batch of the choices that are to be confirmed together. The result supplied by the trustees/servers in this example is both a count code, 45925, and the countersigns for the chosen candidates, 383-123, 763-037, and 248-080. These values are rendered on the screen as shown. The voter places the card 321 as indicated and is to verify that each abutted pair of numbers 325 and 324 is comprised of the same number twice, once on the screen and once on the card.

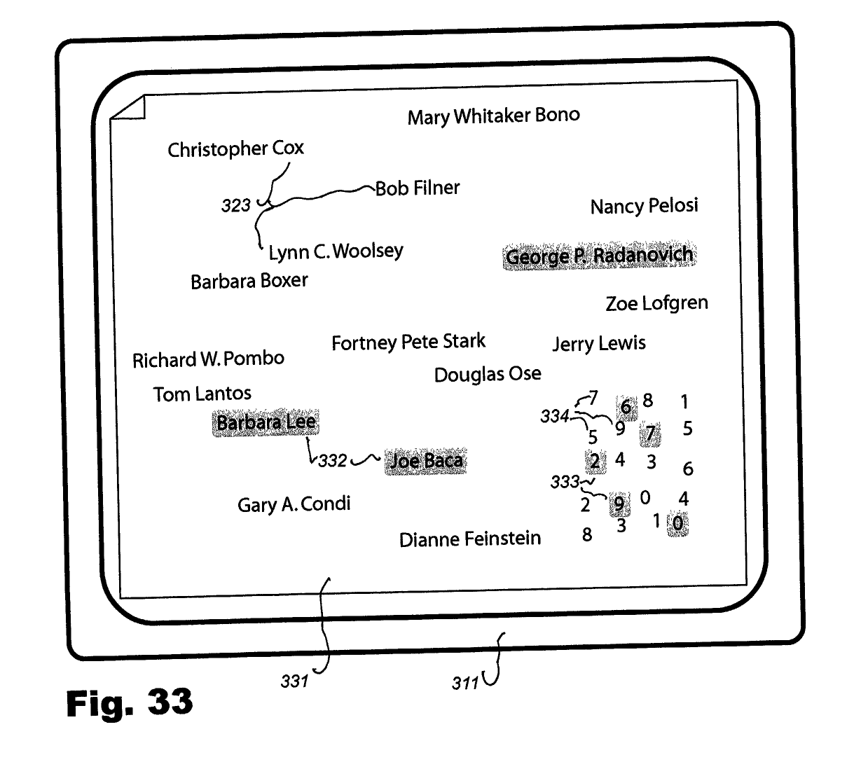

Turning now to FIG. 33, another example combination of a visual display unit and a ballot form in accordance with the present invention is described in detail. The ballot form 331, in this example, can be printed on an ordinary weight of paper, preferably with security properties, that allows light from a display device 331, such as a CRT or backlit LCD, to be adequately visible through it; alternatively, for a reflected-light display, a more transparent form is preferred. All the candidates 323 for three example plurality contests are shown positioned randomly on the sheet, but preferably not overlapping in ways that impair readability. The highlight rectangles 332 show that the display is providing a region of different light properties, such as brighter, dimmer, differently colored, time-varying, and so forth, behind the names of the three candidates chosen, Joe Baca, Barbara Lee and George Radanovich. Also shown is an interactive response code region, where the highlighting 333 indicates the printed symbols 334 that the voter should input to confirm the ballot choice and provide authentication of possession of the ballot, which are ‘6’, ‘7’, ‘2’, ‘9’, ‘0’.

In one example embodiment, not shown for clarity, a login and password, or a combined value, would appear on the ballot and be used to initiate the session. In another example embodiment, not shown for clarity, a cancel code would be printed on the ballot and could be entered at any time, to yield the corresponding response code. Part of the response code might not be printed, to serve as an extra “confirmation code” that can, for instance, be presented by the voter.

In operation, the ballot 331 is printed and provided to the voter preferably in a way preserving its integrity and secrecy, as elsewhere here. The display 311 represents the optionally edited choices of three candidates that the voter has chosen in interaction with the logic controlling the display, which is not shown for clarity. The positions in which the candidates are placed was determined by the logic responsive to information received from the trustee/servers that was itself responsive to serial number and choice information provided the servers. In the example shown, coordinates of where the candidates are located on the ballot are provided from the servers to the display logic. The display logic renders the highlights 332, knowing the dimensions of the candidate names. (In other embodiments, the space for all candidate names is the same and the logic does not know which candidate is in which location; this means that logic that votes an extra candidate has a chance that that will be the one displayed.) Rotation, size, color, and so forth are also aspects that can be matched by the highlights and would also be communicated in those examples. The highlight locations for the interactive confirm code, 333 e.g., would be provided to the logic, but the logic would not know the symbols selected until the voter supplies the code, which the logic would then relay to the servers, who would consummate the lodging of the corresponding votes. A final confirmation to the voter, in one embodiment, can be the highlighting of an additional symbol, such as the words “votes finalized”. A variant would display the digits 334 and print the highlights 333 on the form.

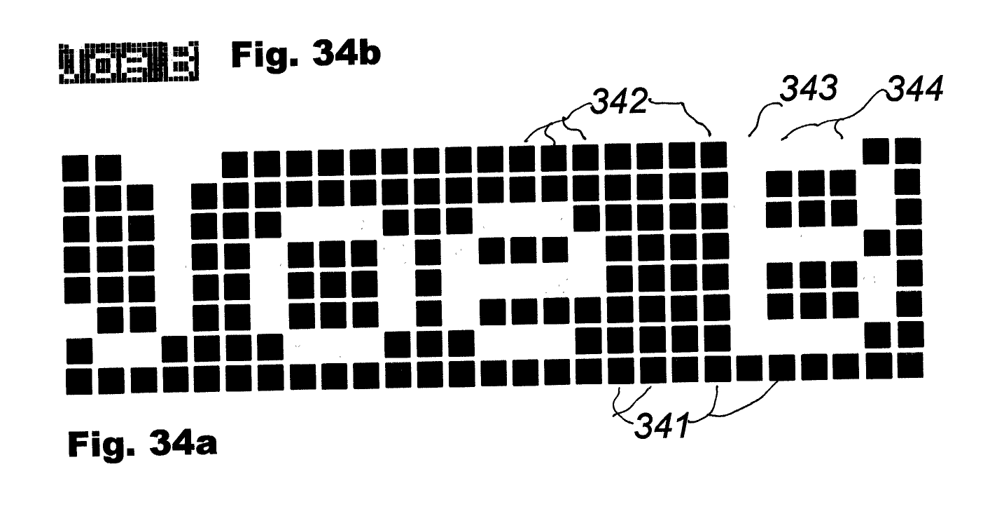

Turning now to FIG. 34, an example securely-printable form in accordance with the present invention is described in detail. The rectangular section of the form is shown in two magnifications, 34a and 34b, so that the ease of reading the candidate name, “Joe B . . . ”, part of the name Joe Boca, the example information printed, can be more readily appreciated at close proximity. What is shown is a region of a special paper form that comprises two different types of original pixels, 341 and 342, the pattern of their placement being preferably apparently random and secret to the trustees, in the example of a standard sort of rectangular array. Also shown are two different result types of pixels, 343 and 344, arranged to encode in a standard 5 by 7 matrix a prefix of the name of a candidate. Thus, there are four combinations of resulting pixels shown, 341-344. In an invalidly-printed form, the wrong printing would typically be applied to at least some preprinted pixels, 341 or 342, resulting in a preferably recognizable error. Naturally the size, placement, and number of types of pre-printed and post-printed pixels can be varied.

In an example use, the medium would be printed by printers responsive to secret inputs supplied by trustees as already described, except that the results would indicate which materials/treatments to apply to which pixels/regions. The bit supplied by each trustee for a particular pixel can be exclusive-or'ed to obtain the result. Then this pre-printed medium would be provided to a user and/or directly to a printer, not shown for clarity. The printer would receive information from the trustees indicating what to do to various pixels, but preferably not indicating the status of all the pixels, so that the printer should be unable to print arbitrary images. In the example, the printer is provided one bit for each pixel making up the 5 by 7 code only for the chosen candidates. When the printer applies the corresponding solutions determined by the bits, the result should be, assuming registration has been correctly accomplished by the printer, the desired image. In the example, the bits of the background would preferably not be revealed by easily measured differences, such as reflectivity used for illustration purposes here. Also, both types of printed pixels would preferably appear to be the same to the user, although they are shown as different here for illustrative purposes.

In the present example, the background colors, 341 and 342, would be printed with two different types of relatively dark ink, that preferably have the same color and general appearance. The inter-pixel gaps can be used for registration and would be unprinted. The two types of liquid applied, such as by a bubble-jet printer, with optical registration mechanism, would be specific ink removers. That is, one type of ink remover would work on the type of ink S pre-printed on 341 and the other type of ink remover would work on the other type of ink, that pre-printed on 342, with the result in both proper cases being preferably similar looking and substantially in visual contrast to the pre-printed inks 341 and 342.

Many types of inks and ink removers are known in the related art and are believed suitable. Naturally, the wrong specific remover applied to a pixel would preferably not give a visual result similar to the correct one. It is also preferable that no single ink remover formula, that can readily be discovered and produced, will remove both inks to the same appearance as the specific ones. One technique for enhancing this property would be, as suggested elsewhere, to include “traps” with the pre-printed ink that are activated by less specific removers and that create hard to remove visual characteristics, such as bright colors. An example such trap is a micro-encapsulated die and reactive agent whose encapsulating material is solved by non-specific removers including the other specific remover.

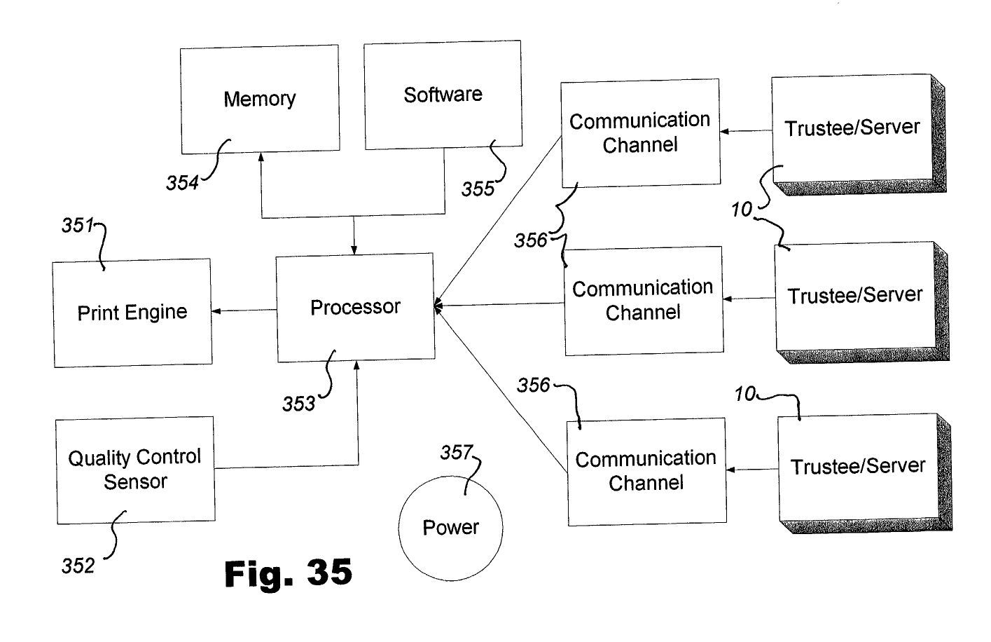

Turning now to FIG. 35, an example printer functional, block, and schematic diagram in accordance with the teachings of the invention is presented. The “print engine” 351 is the device that actually puts ink on paper, or the like, such as currently accomplished by well known technologies referred to by names such as ink-jet, laser-printing, thermal printing, die-sublimation printing, laser engraving, and so forth. The “Quality control sensor” 352 is an optional device that reads before and/or after printing and/or monitor aspects of the print engine 351, producing signals indicative of quality of print that are supplied to the processor system 353 shown. The processor 353 is shown interacting with a memory device 354, that stores various temporary values, and with a software memory 355, that stores and supplies software. In order to verify that the printer system is not properly retaining information, this memory means 354 can have provision for resetting its state to a known state, such as are well known as zeroing or reset circuits. To the extent that the processor 353 has internal state, this should also be subject to reset.

Three example “Communication channels” 356 are shown interfacing the processor 353 with three example trustee/servers 10. These channels 356 are intended to serve as one-way firewalls, strictly preventing the outflow of information. As will be appreciated, but not shown for clarity, any number of these can be arranged in serial to provide improved protection. Power means for the system 357 apart from the trustee/servers and network is shown for clarity not connected to each component part.

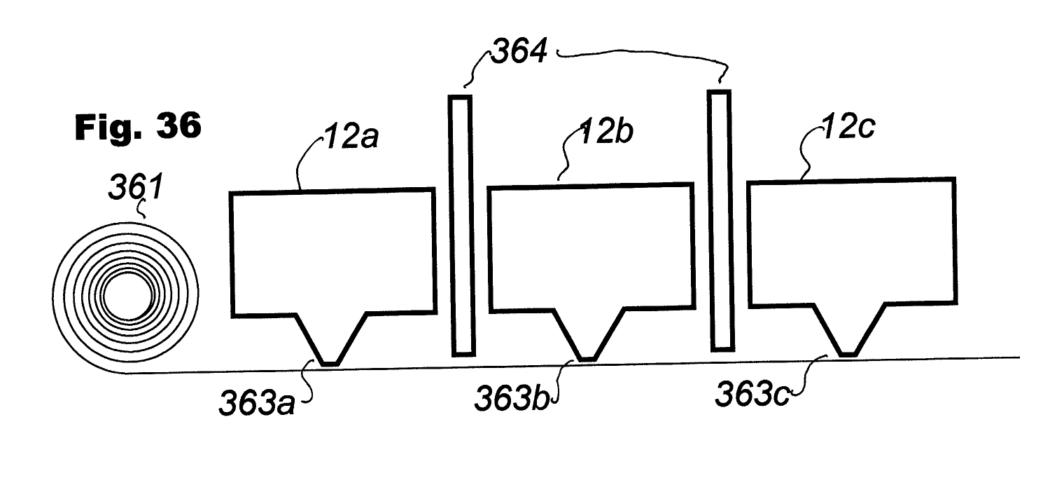

Referring now to FIG. 36, an example serial configuration of multiple printers is illustrated in a combination block, functional, and schematic diagram and in accordance with the invention. The roll 361 of paper stock 362 on the left is fed through three printers 12a, 12b, and 12c, having print heads 363a, 363b, and 363c. The independence of the printers is provided in part by the partitions 363 between printers shown. One or more printers may, for example, place hiding coatings over what they print and/or the final result could be placed in envelopes.

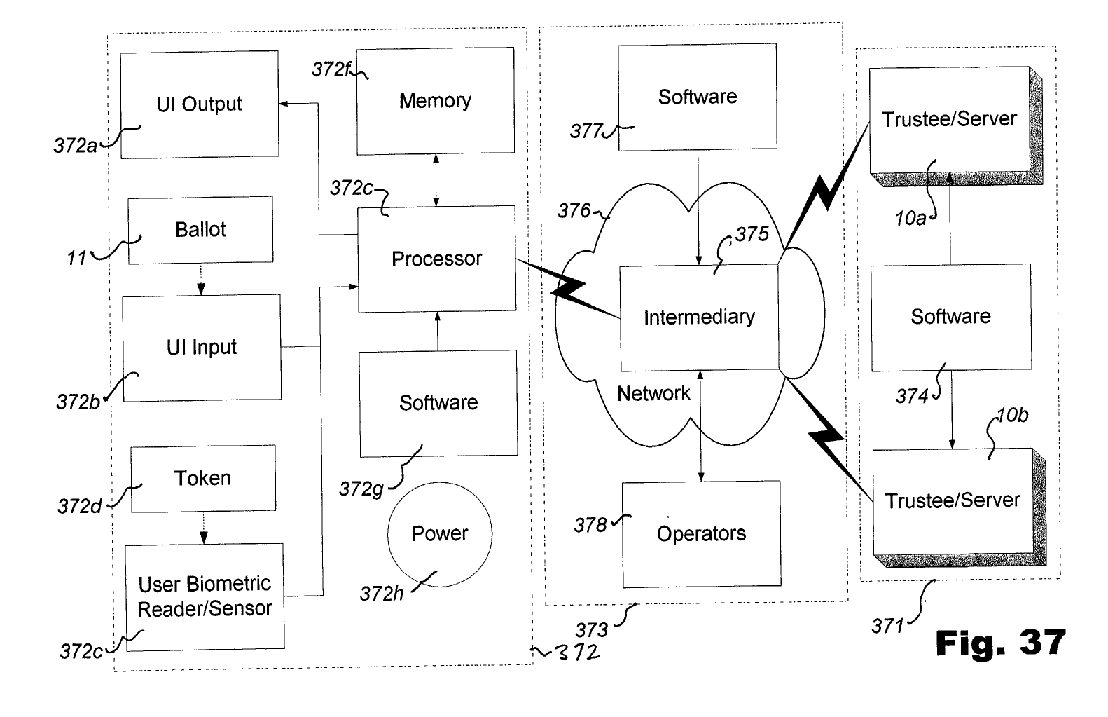

Turning now to FIG. 37, an example combination schematic, functional and block diagram for an exemplary networked voting system in accordance with the teachings of the present invention is presented. There are three functional groups: the trustees 371, the user station 372, and all the mechanism/functionality in between 373 that will be called the network/intermediary. The individual trustee/servers 10a and 10b, shown as examples, perform operations controlled by program steps supplied by software 374. Each trustee/server 10 can be a whole network unto itself, but is shown as a single block. Each trustee/server is shown communicating with the middle layer, the network/intermediary 373, directly, although various intermediate firewalls, intermediate nodes, routers, as are known in the art, and so forth may be interposed and/or shared by trustee/servers 10. When some voting is attendance some non-attendance, as one example, the trustees 10 may use different intermediaries 373 for each, and the user station 372 and network/intermediary 373 functions may be repeated in one or more additional layers not shown for clarity.

The middle layer 373 shows an intermediary 375 (that may or may not be a relay 14) communicating over a network 376 to the trustee/servers 371 on the right and the terminals 372 on the left. There can be multiple distributed and redundant intermediaries 375, all of which can communicate with the trustees 10, directly or indirectly, but only one or a few of which communicate with each terminal 372 at a time. Known structures for real-time transaction processing systems can be used to implement the intermediary 375. Whatever network(s) can also be used, even though one is shown 376. The intermediary 375 operates according to programmed instruction software 377 shown.

Depending on the configuration, and optionally dynamically according to the terminal session requirements, human operators 378 may be involved and communicate through the intermediary 375. Some examples are traditional call center operators that interact with voters directly verbally, or by any combination of media, such as including computer data, voice, and video. Operators 378 can perform the intermediary function of obtaining vote codes and returning countersigns. They can also provide help desk functions, and monitor operations.

The voter terminal 372 can, as one example, be a telephone instrument attached to the public switched telephone network, whether or not wireless, that connects to the intermediary(s) 375, customarily after conversion through a private branch exchange or other suitable gateway. In such an example, the voter 13 can vote using well known interactive voice response systems that prompt for challenges, either voiced or touch-tone, and issue responses in a programmed way. Voters 13 using such terminal equipment 372 can also vote by interaction with human operators 378, as already described, and/or through a hybrid that allows both possibilities based on such things as voter preference, error rate, and resource availability. In another example use, the party interacting over the phone would actually be a relay 14 to an actual voter.

Voter terminals 372 can, in another example, be a reader, foil-reader, or other reading device, as already described elsewhere here. In such configurations, each such terminal can be connected to the network 375 shown here itself, such as by direct participation in a public wireless network. Or, there can be one or more concentrators, switches, hubs, routers, gateways, firewalls, and so forth connecting reader equipment together locally and also to the network shown, all as is well known in the digital communication art.

The voter terminals 372 can, in another example, be a more powerful and more general-purpose device, such as a personal computer, network appliance, or whatever form of apparatus evolves from and/or replaces them. In one example, such a device could perform the functions of a telephone instrument, and the interaction can be much as already described. In another example embodiment, the terminal 372 would implement a voice response system of its own, providing much the same function as already described for the intermediary.

In yet an other example of such a case, the device may be a so-called “web browser” or the like and the intermarry 375 a so-called “web server” or the like. The intermediary 375 would then realize preferably-idempotent transactions implementing a transaction processing environment, that would offer forms or other structures for voter input of challenges and serve pages indicating responses. Other ancillary pages would provide assistance and additional information and convenience functions, such as help, support, session management, and so forth. A cryptographic session would be established to secure communication, and it can extend for a single transaction or over multiple contests, for example.

The UI (“User Interface”) output device(s) 372a shown can be visual, verbal, tactile, or whatever combination, and be ephemeral or yield records of varying degrees of permanence. The UI input devices 372b can translate physical motions, gestures, auditory, or whatever information provided -by the voter. In some cases, such as with the readers already described, they may include the ability to scan, or otherwise capture visible or near visible reflectance of the ballots, such as by video camera, and translate this information for use in performing the intermediary function. The line from the ballot 11 to the UI input 372b is shown broken, to suggest that there may be an automatic reading or voter 13 will read the ballot and provide the information to the device 372b.

The “User Biometric Reader/Sensor” 372c comprises devices that can determine information about the voter 13 that can be used to authenticate the voter. Examples include fingerprint, voiceprint, face recognition, and so forth. The token 372d shown is intended to support such authentication and/or provide additional security related functions of a secured storage, cryptographic functions, voter authentication including biometrics, display, input and so forth. The token 372d may communicate with the reader 372c directly, or data may be relayed between the two by the voter 13.

Also shown is processor 372e using memory resource 372f, and under program control of software 372g. The whole device 372 can be powered by power source 372h.

Turning now to FIG. 38, an example reader in side view and corresponding section through a ballot being read all in accordance with the invention will be presented. The figure shows a view from the side, perpendicular to the ballot 11, of the reader 381.

Visible on the reader is the receiving data capture sensor, “read head” 382, located in proximity to the ballot 11, which, as mentioned already can preferably read printed data at a limited range. Also, an input device button 383 is an illustrated example of a way to take input from the voter 13 and, unlike many buttons, to optionally give feedback since the button can as also discussed elsewhere be “locked up” to prevent its being pushed until the reader logic allows it to be. Additionally two exemplary output means are shown, one is a display 384 for showing countersign information at least and the other is an optical/audible emitter 385 for providing whatever feedback/information to the voter. Not shown for clarity are processing/memory, power and communication means, as will be presented elsewhere.

Positioned under the read head 382 is the example ballot card II part with folded corner 11a

One example function of a reader is to assist the voter by providing indication of or even preventing out of protocol actions by the reader. For instance, if the voter tries to overvote a contest, the reader could make a sound or lockup. As another instance-of many possible examples, if a voter tries to confirm using the wrong vote code, this could also be alarmed/blocked.

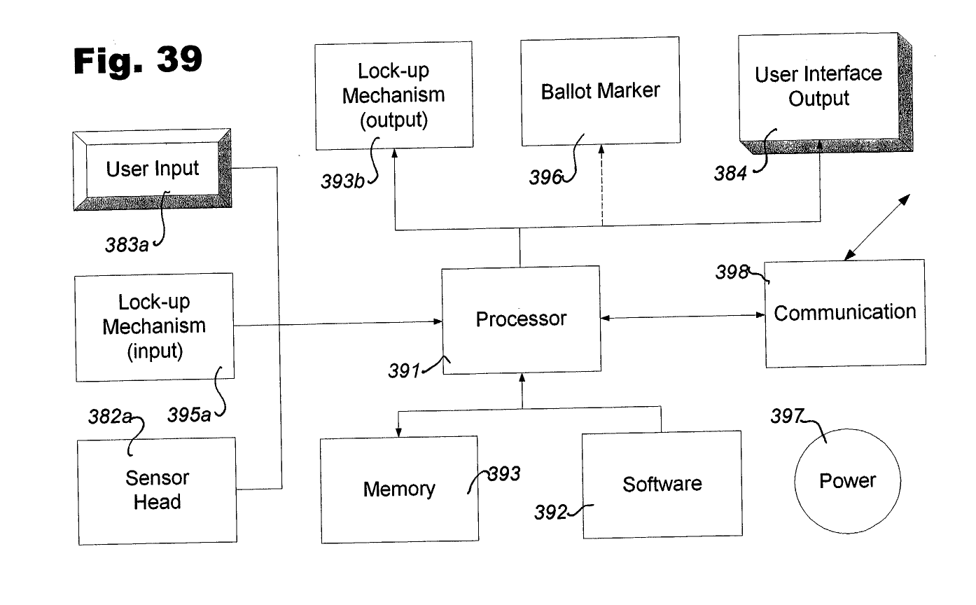

Referring now to FIG. 39, an example combination schematic, functional and block diagram for a reader in accordance with the teachings of the present invention is presented. A processor means 391 is shown, which can be any suitable digital structure, with any number of program interpretation and associated resources. In particular, software 392 configured to provide instruction control to processor 391 s shown and memory resources 393 for state and scratch are also depicted. Processor 391 receives primary input from the user input 383a, which can be a button 383, sensor head 382a, and communication subsystem 394, all shown, and ancillary input from the others, such as quality control for lockup 395a or ballot marker 396. Similarly processor 391 provides controlling output to the user interface output 384, lockup mechanism 395b and ballot marker 396 (optionally, for leaving marks on ballots 11, shown with a broken line as input from processor 391 to highlight for this case that in some embodiments it does not take controlling output from the processor) and any needed ancillary output to the other devices. Connection of power source 397 to all devices is not shown for clarity. Each of the parts shown can, in some embodiments, be omitted and/or appear more than once.

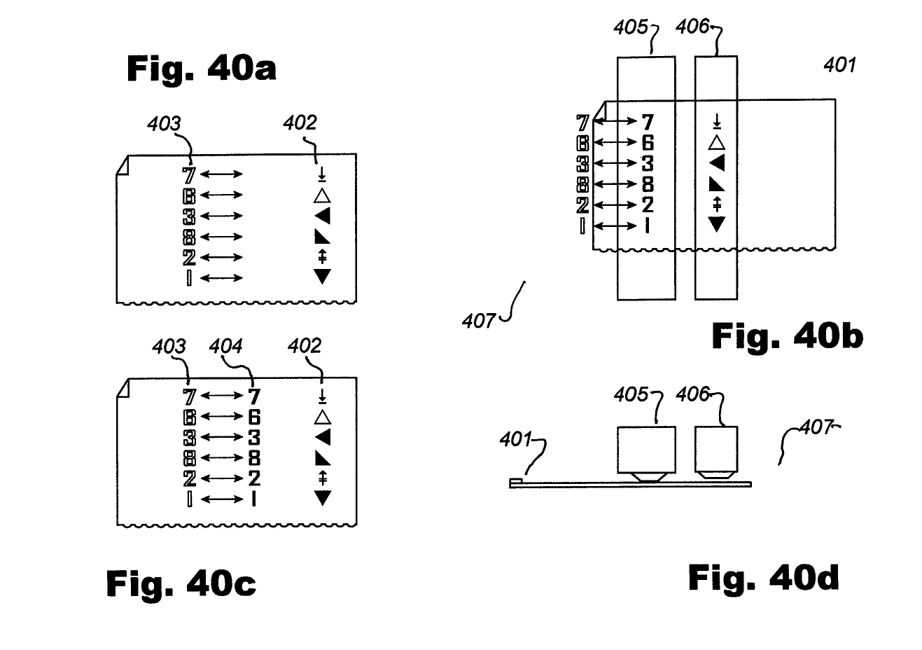

Turning now to FIG. 40, an example counterfoil reader/writer in accordance with the invention is shown in combination block, plan, schematic, and section illustrations. The upper left quadrant, 40a, shows a ballot counterfoil 401, detached from the ballot, but before being inserted into the counterfoil reader; the reader is shown in plan view 40b and from the side 40c; and the lower left quadrant 40d shows the resulting counterfoil. The right column 402 of counterfoil 401 is intended to be read by the counterfoil reader. The left column 403 is the countersign that the reader should independently derive and print a copy of right of the arrows, 404. The reader is shown from above in 40b in a section from the top; and, in 40c in a section from the side. The rectangular block on the left is printer 405, that on the right is an optical sensor 406 to read the right column on the counterfoil. The shaded region 407 depicts a recess into which the counterfoil 401 can be placed, but substantially not when the ballot II remains attached.

In operation, first the voter detaches the counterfoil 401 from the ballot 11 so that it can be inserted into the counterfoil reader recess 407. It is inserted in the orientation shown, because of alignment mechanisms not shown for clarity, such as notches or missing corners. The reader 406 then reads the symbols 402, which constitute a control vote code, provides them to the servers, and receives the corresponding countersign. This countersign 404 is then printed by printer 405 and the counterfoil 401 can then be removed from the counterfoil reader. At any point after this, the two copies, 403 and 404, of what should be the same countersign can be compared for equality by anybody inspecting the counterfoil 401. If the two do not match, the serial number on the back-side not shown for clarity can be used to void the ballot 11 and allow the voter 13 to cast a new one. Such a counterfoil 401 would also indicate serious problems and can be expected to be investigated.

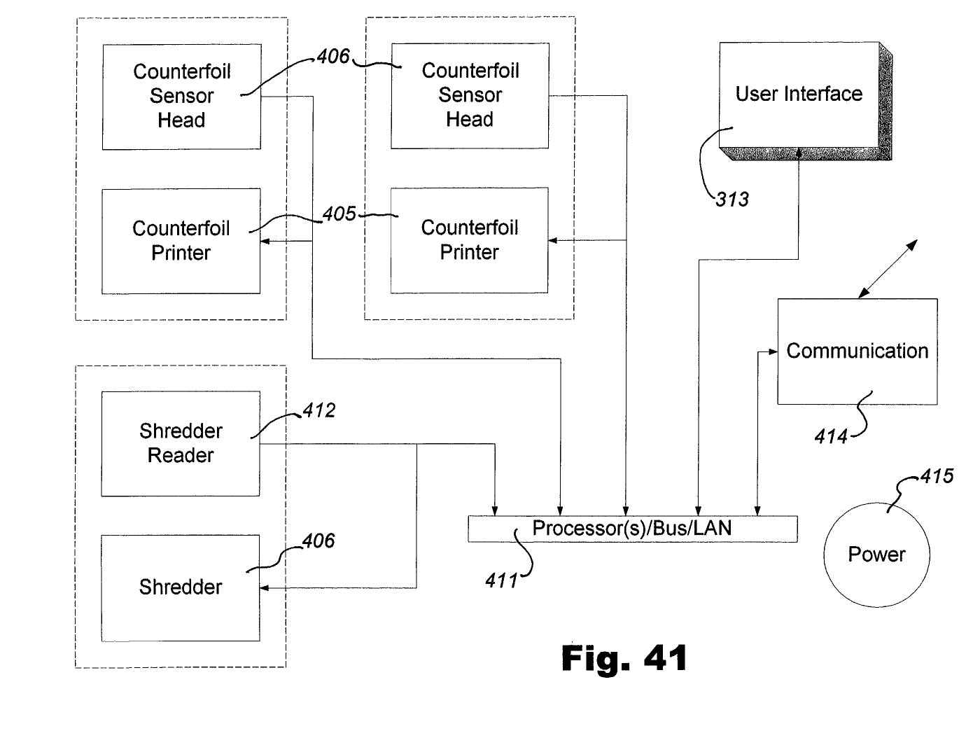

Turning now to FIG. 41, an example combination schematic, functional and block diagram for a exit processors in accordance with the teachings of the present invention is now presented in detail.

As will readily be appreciated, the counterfoil reader can have many of the same functions as the voting readers already described with reference to FIGS. 38 and 39, and all the detailed description for voting readers that is applicable, may be taken to apply to the counterfoil readers as well.

The “Processors(s)/bus/LAN” 411, which is referred to as logic for clarity, is shown connected to various component parts of the system and is intended to show the digital processing/control functions for the various connected parts, without regard to where they are physically located or the extent to which they are or are not shared. For example, logic could be a LAN that all the other devices hang off of, or it could be a single processor that directly controls the other devices, or it could be a bus structure connecting various processors that each control part of the exit processor system.

Various configurations are anticipated, including a single unit containing all the functions, a distributed version where each function is realized by one or more separate devices, and various grouping and clustering in between. This logic receives primary input from the sensor heads 405, the shredder reader 412 and the user interface 413; it provides primary control to the counterfoil printers 405, shredder 406, user interface 413 and communication interface 414. Ancillary input and output is not shown explicitly for clarity. Connection of the power source 415 with other devices is not shown for clarity.

While two sensor/printer parts are shown, as these are preferably separate for exemplary conunit and cancel functions, each of the units in dashed boxes and the user interface can appear in an actual system in whatever multiplicity and combination as may be advantageous.

All manner of variations, equivalents, and adaptations can readily be conceived by those of skill in the art.

While these descriptions of the present invention have been given as examples, it will be appreciated by those of ordinary skill in the art that various modifications, alternate configurations and equivalents may be employed without departing from the spirit and scope of the present invention.

What is claimed is:

1. A voting system method comprising:
at least one trustee establishing confidential challenge and response values;
at least one printing device printing media responsive to the confidential values;
transferring an instance of the printed media to a voter;
the voter voting by supplying confidential challenge information contained in the printed media and corresponding to at least one vote to the at least one trustee; and
confirming from the at least one trustee to the voter, by using corresponding confidential response information, that the at least one vote was received by the trustee.

2. A trustee method comprising:
supplying first confidential challenge and corresponding response values by at least one trustee to at least one printer system for printing on media; and
receiving by the at least one trustee challenge data from those who have obtained printed media;
responding by the at least one trustee to the received challenge data related to the challenge information with the corresponding response information.

3. A security printing method comprising:
receiving confidential information intended to be included in printed ballots from multiple sources;
hiding the individual contributions by combining the confidential information to result in challenges and responses; and
printing the challenge and response information on media to produce an article encoding the combined information.

4. A security printing system comprising:
mechanism to receive from multiple sources confidential information intended to be included in printed ballots;
combining mechanism for hiding the individual contributions by combining the confidential information to result in challenges and responses; and
printing apparatus printing the challenge and response information on media to produce an article encoding the combined information.

5. A security intermediary method comprising:
establishing by an intermediary communication with a first entity;
establishing by the intermediary communication with a second entity;
receiving by the intermediary requests from the first entity that include the confidential information;
forwarding by the intermediary the requests to the second entity; and
the intermediary being unable to falsify the choice of candidates made by the first entity and received by the second entity.
